(19) United States
(12) Patent Application Publication
(10) Pub. No.: US 2017/0169175 A1
(43) Pub. Date: Jun. 15, 2017

(54) PATIENT CARE MANAGEMENT SYSTEM

(71) Applicants: Michael GRAFF, Seattle, WA (US); Gena COOK, Seattle, WA (US); Carin OVERTURF, Seattle, WA (US); Richie MORRIS, Seattle, WA (US)

(72) Inventors: Michael GRAFF, Seattle, WA (US); Gena COOK, Seattle, WA (US); Carin OVERTURF, Seattle, WA (US); Richie MORRIS, Seattle, WA (US)

(21) Appl. No.: 15/266,670

(22) Filed: Sep. 15, 2016

Related U.S. Application Data
(60) Provisional application No. 62/219,003, filed on Sep. 15, 2015.

(51) Int. Cl. G06F 19/00

(52) U.S. Cl. CPC G06F 19/3418; G06F 19/322; G06F 19/3456; G06F 19/325; G06F 19/326

(57) ABSTRACT

Embodiments for automated patient care management are provided by a platform. A patient application executes on a remote device and is configured to present patient data inquiries and, in response, receive patient data at the remote device. The patient data includes data of medication and physical condition. A provider application executes on the platform and is configured to receive and process the patient data from the remote device. The provider application and/or the patient application generates the patient data inquiries using information of the patient data reported during at least one prior session. Numerous provider dashboards include the patient data and controls for interacting with the corresponding patient and recording care data. The provider application, which includes the classification and care notifications on the provider dashboards, automatically controls classification of patients and generates care notifications based on the patient data.

### RELATED APPLICATION

This application claims the benefit of U.S. Patent Application No. 62/219,003, filed Sep. 15, 2015.

### TECHNICAL FIELD

The embodiments described herein relate to applications running on one or more processors and, more particularly, forming a system of components configured to automatically manage patient care, including processing and management of patient and treatment data.

### BACKGROUND

There is a need for systems, devices, applications and/or methods for automated care management, and processing of patient care information or data.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the care management system, under an embodiment.

FIG. 2 is a flow diagram of the care management system or solution, under an embodiment.

FIG. 3 is a flow diagram of the Health Tracking and CCM programs, under an embodiment.

FIG. 4 shows an example Patient Engagement Portal generated by the care management system, under an embodiment.

FIG. 5 is a flow diagram for patient reporting of the patient component, under an embodiment.

FIG. 6A is an example daily check-in page for medication consumption reporting, under an embodiment.

FIG. 6B is an example daily check-in page for additional medication information reporting, under an embodiment.

FIG. 6C is an example of a general side effects reporting page, under an embodiment.

FIG. 6D is an example side effects reporting page including a list of prevalent side effects, under an embodiment.

FIG. 6E is an example side effects reporting page including relatively more comprehensive list of side effects, under an embodiment.

FIG. 6F is an example side effects reporting page on which one side effect (“A new or increasing pain”) is selected, under an embodiment.

FIG. 6G is an example side effects reporting page on which two side effects (“A new or increasing pain” and “Fatigue”) are selected, under an embodiment.

FIG. 61I is an example side effect severity (pain) reporting page, under an embodiment.

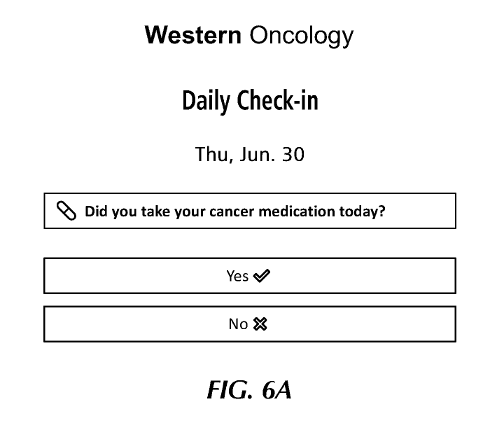

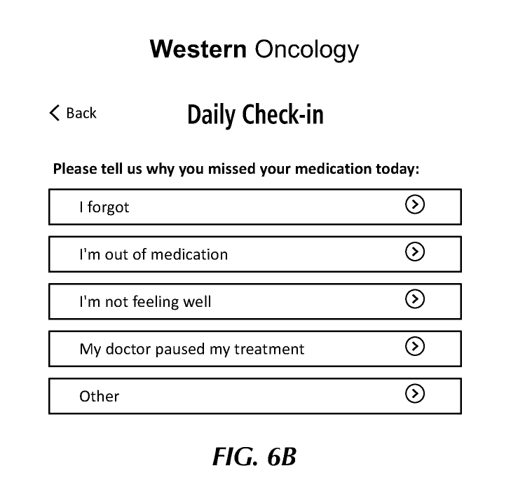

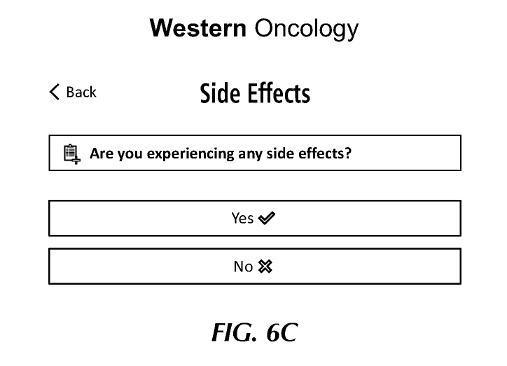

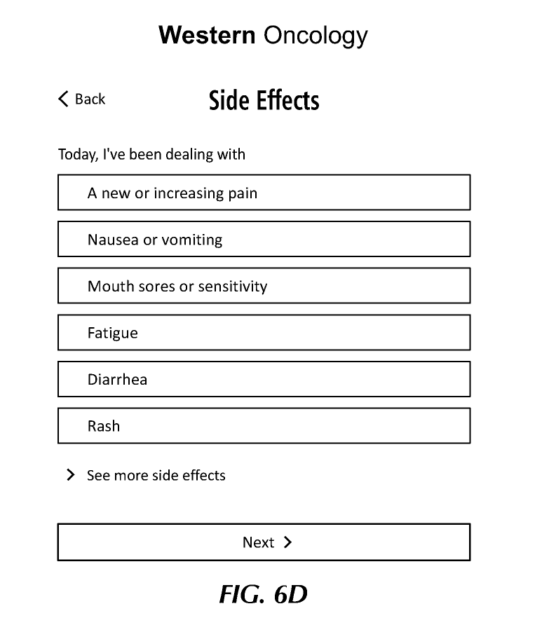

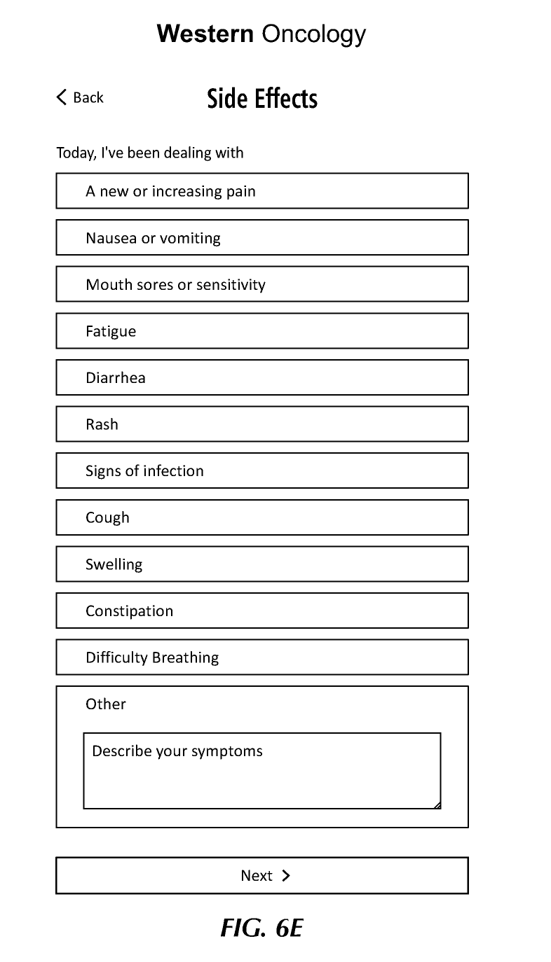

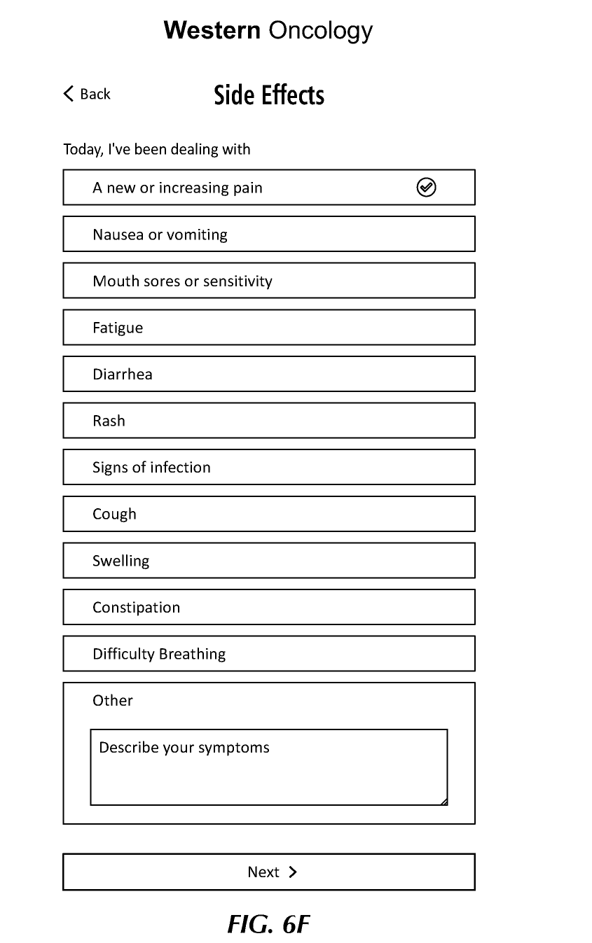

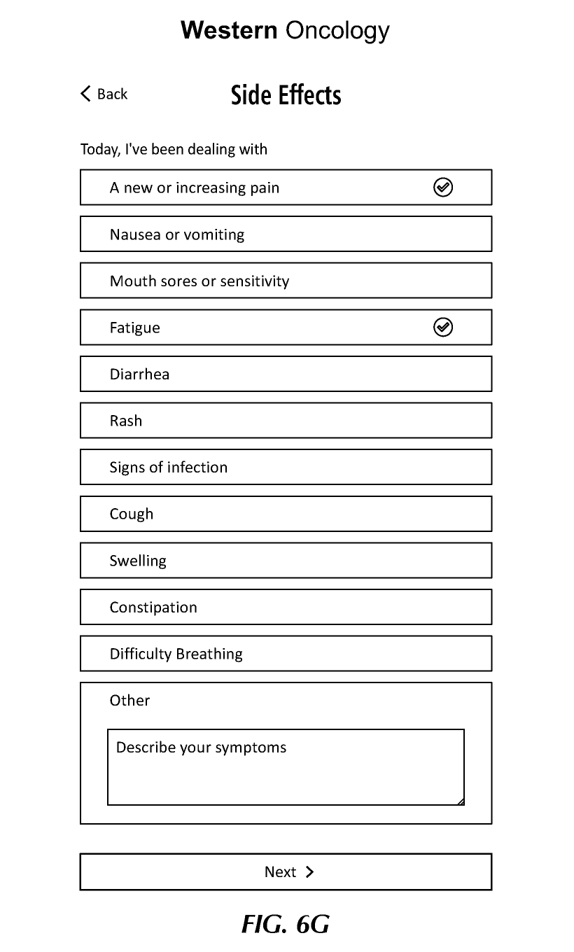

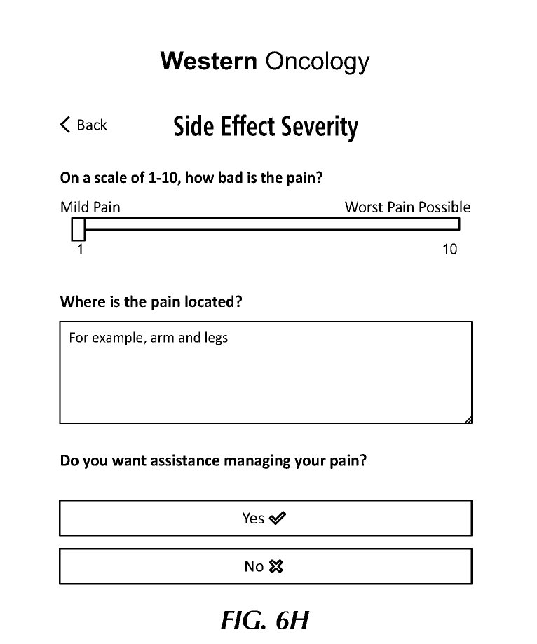

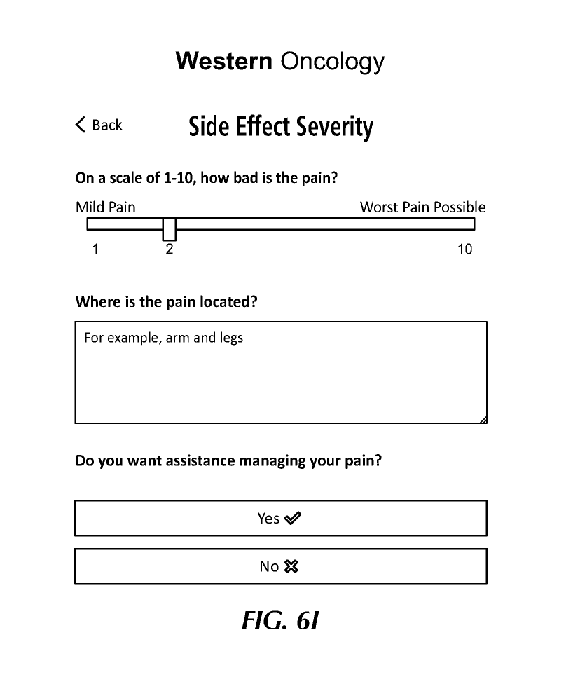

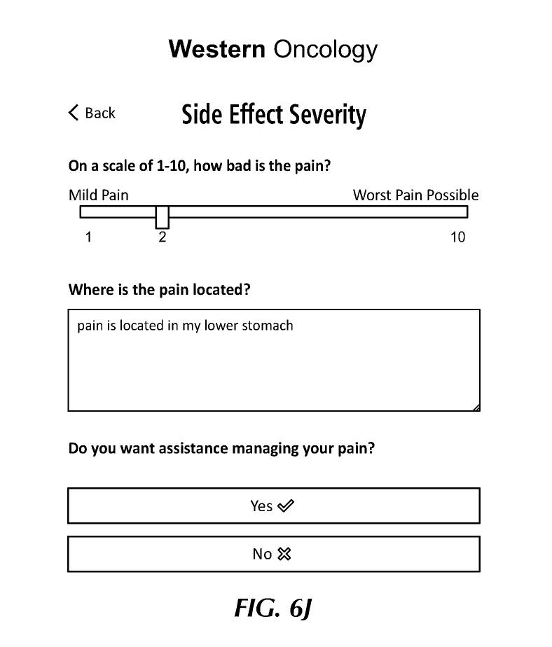

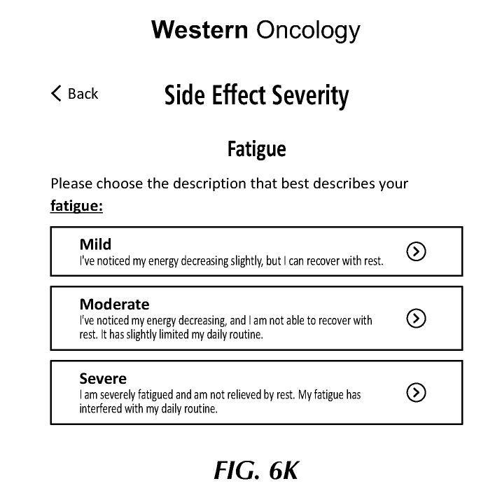

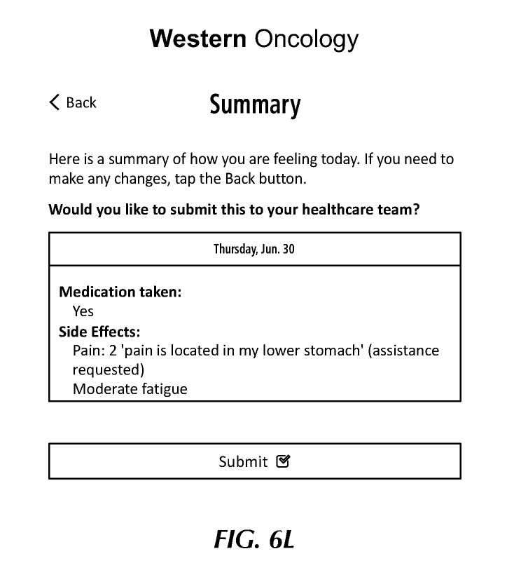

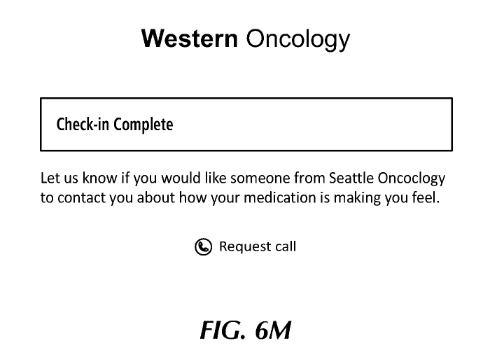

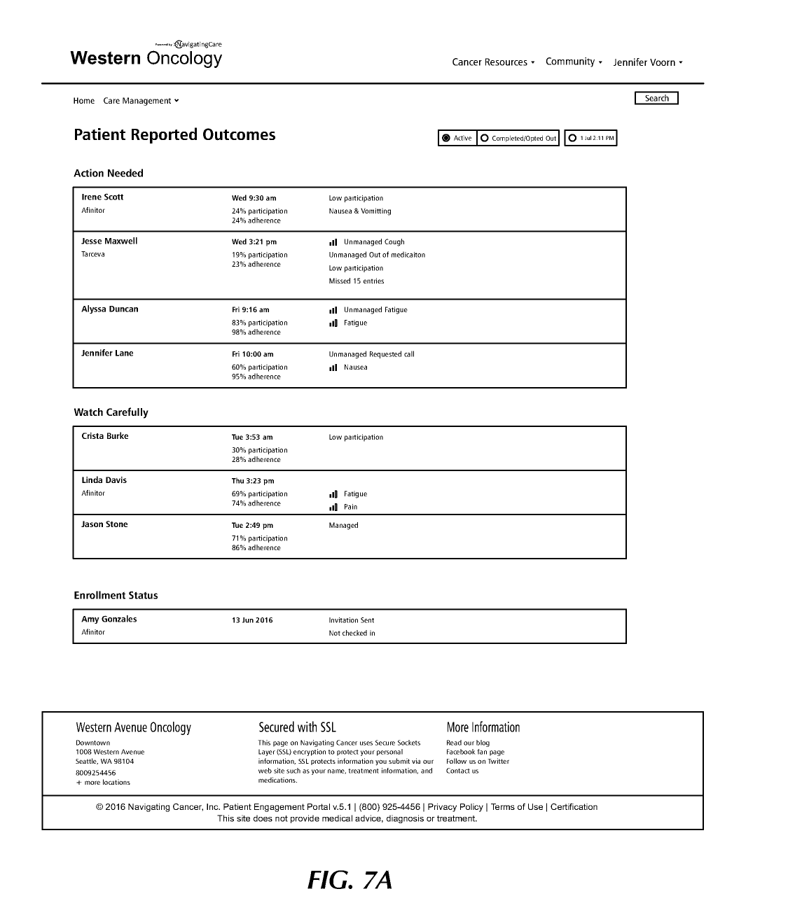

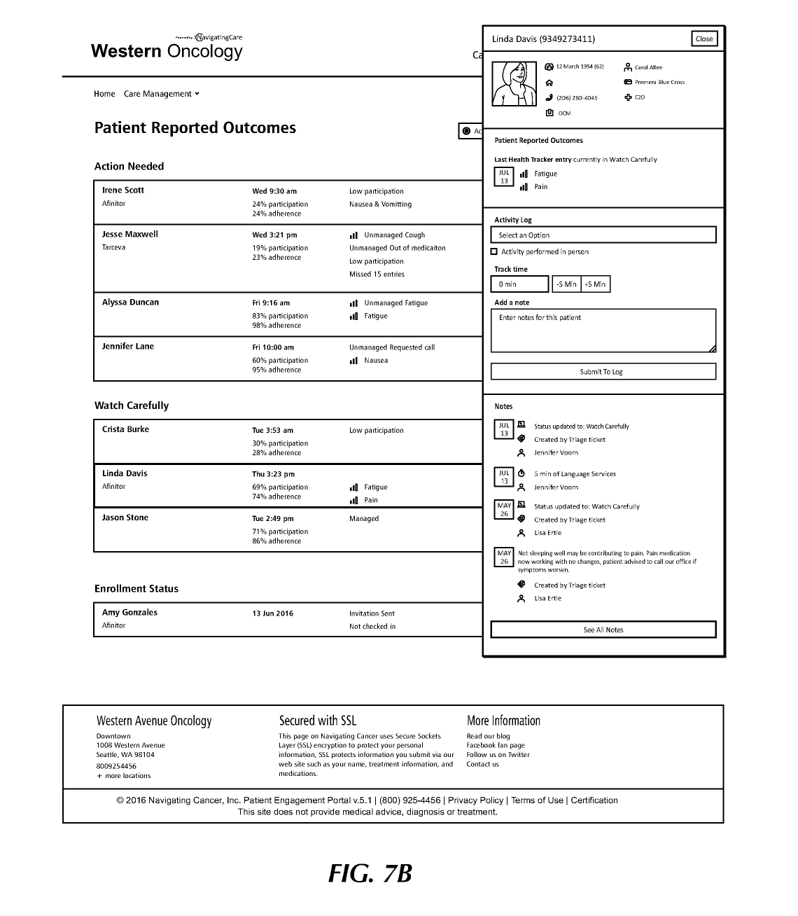

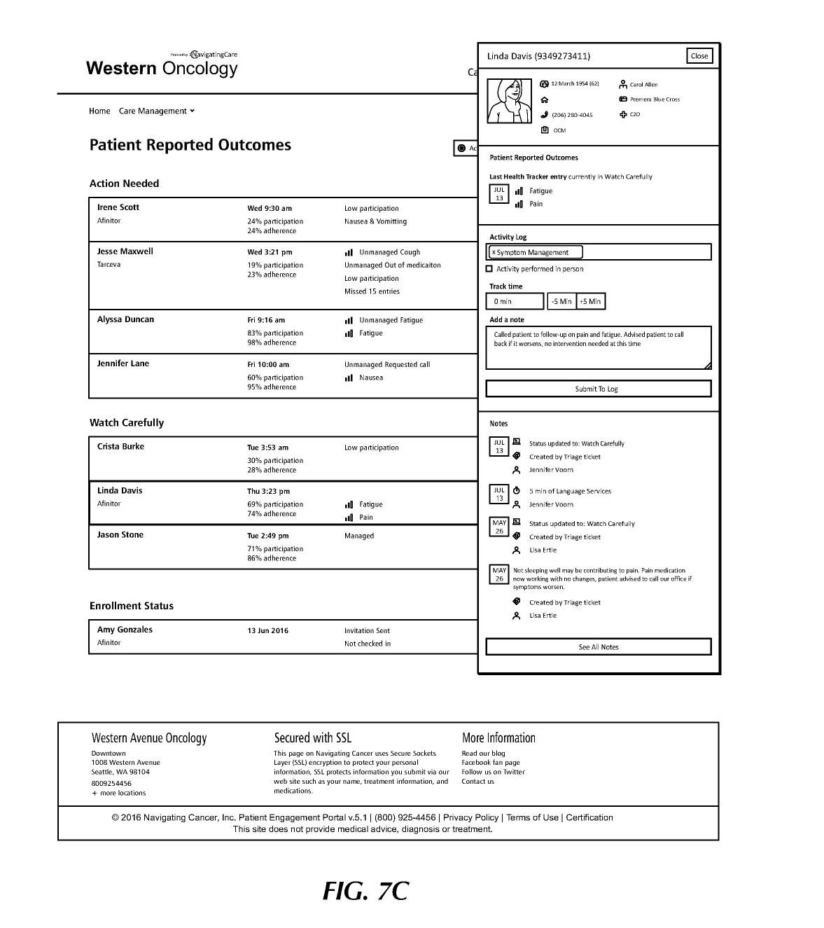

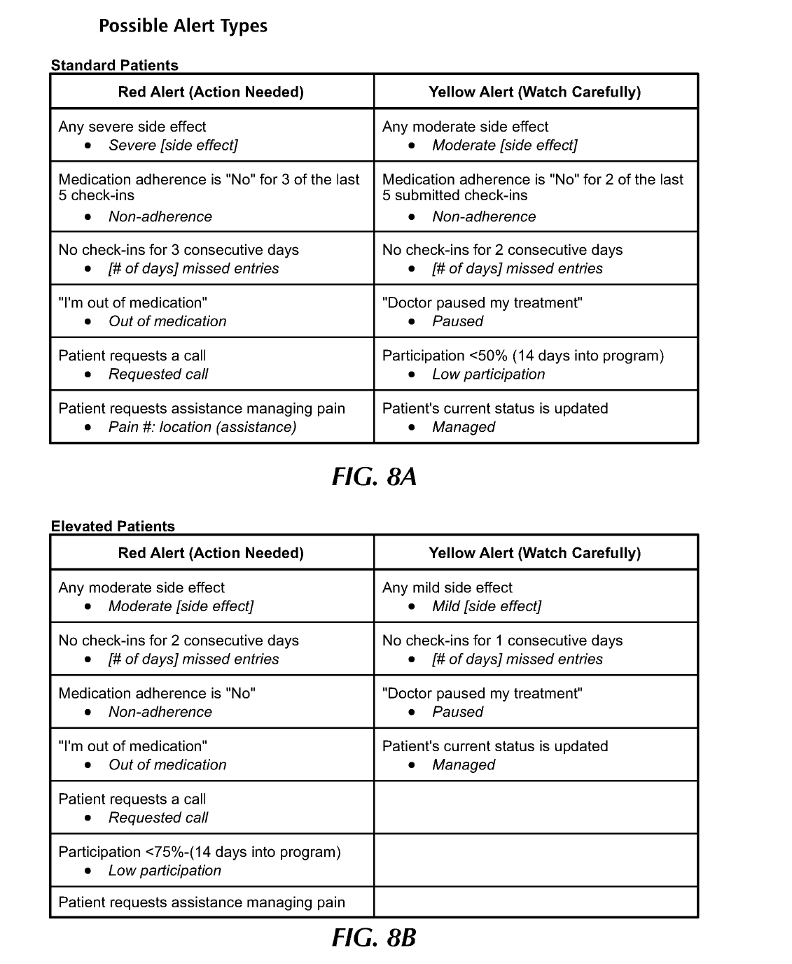

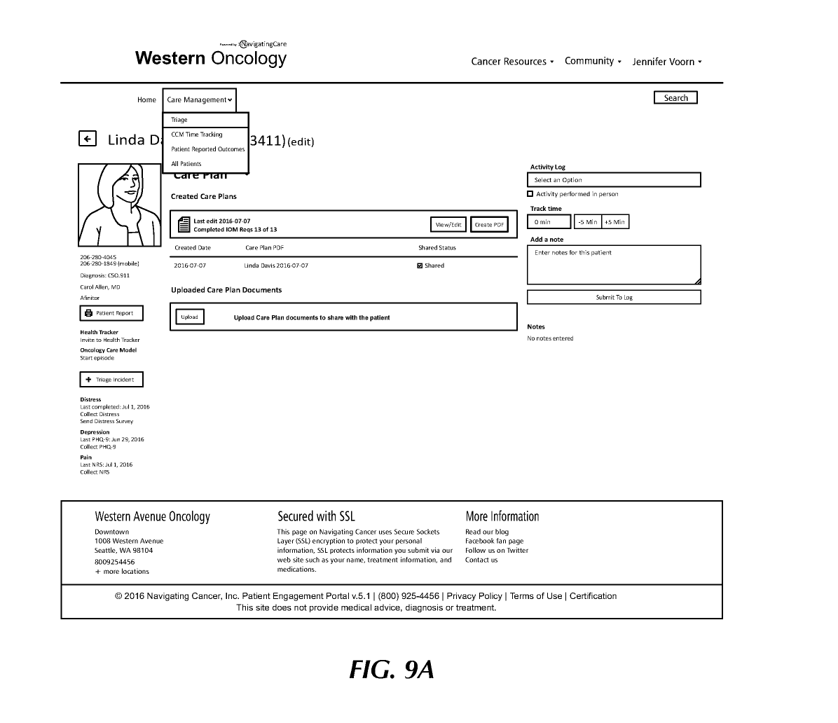

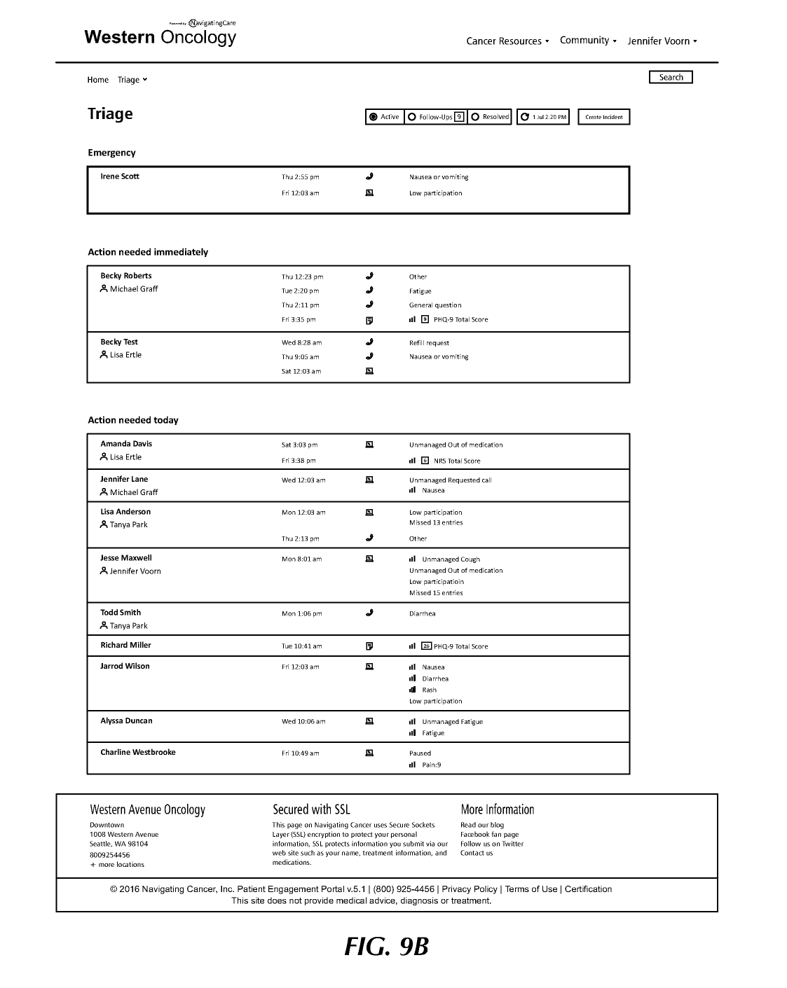

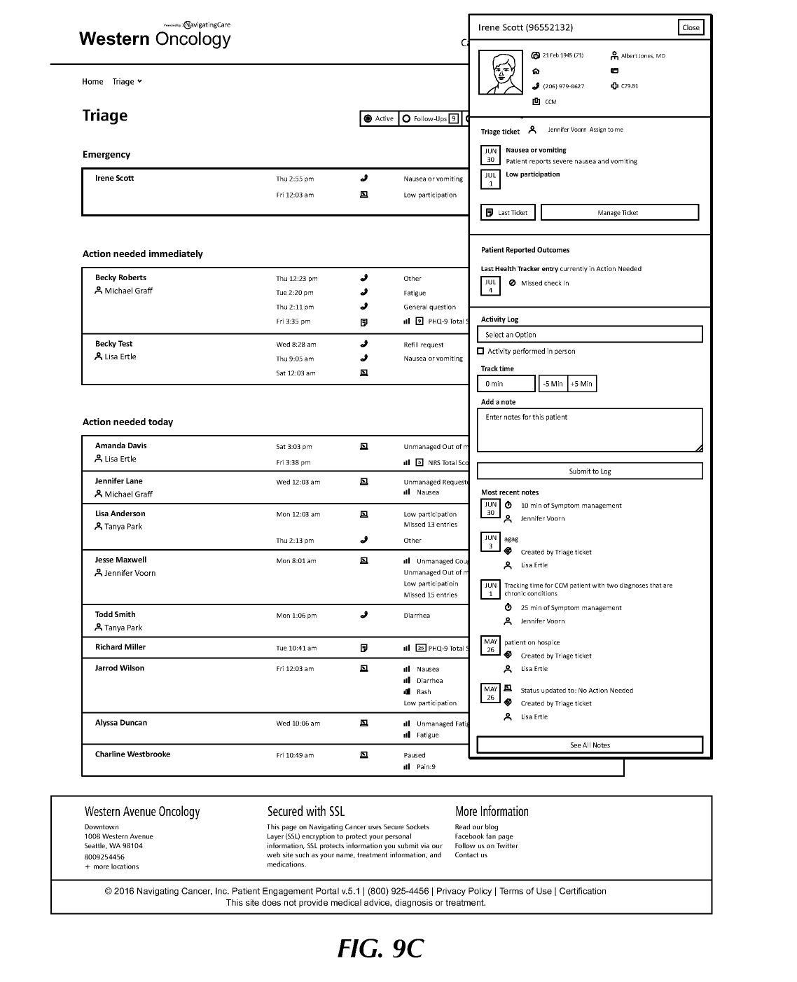

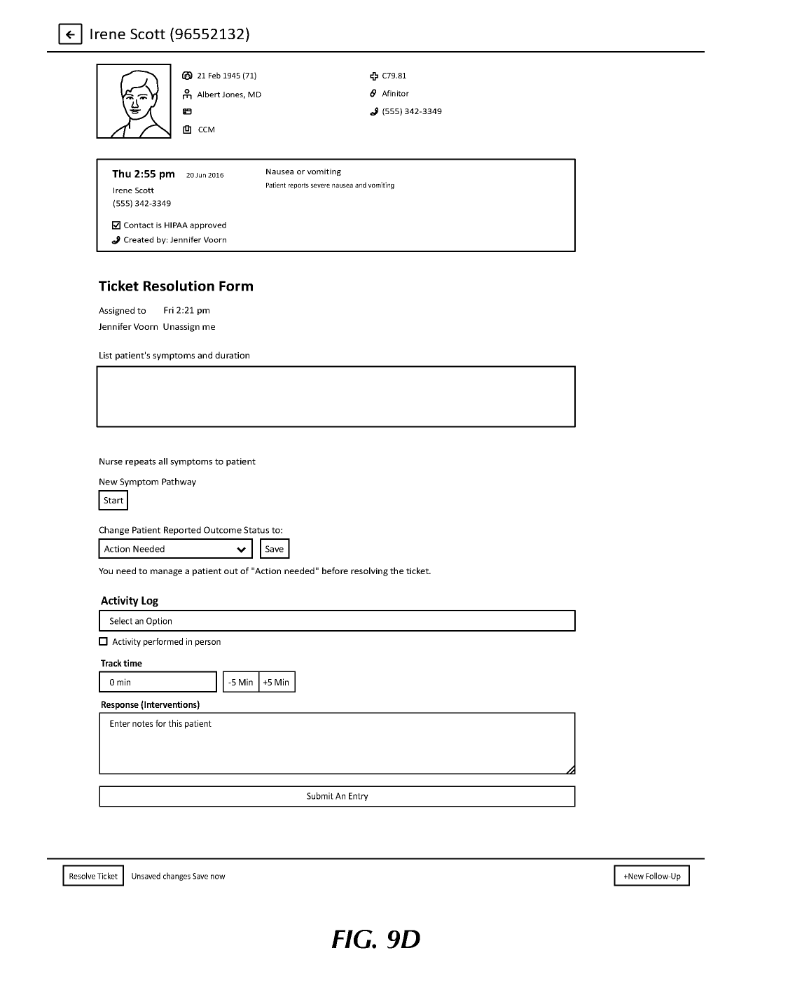

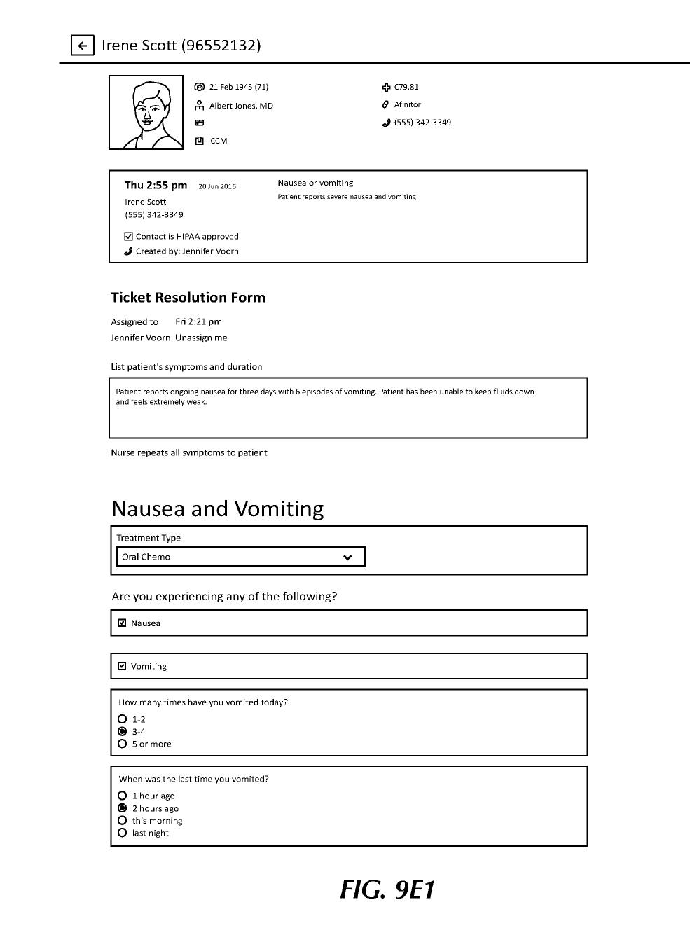

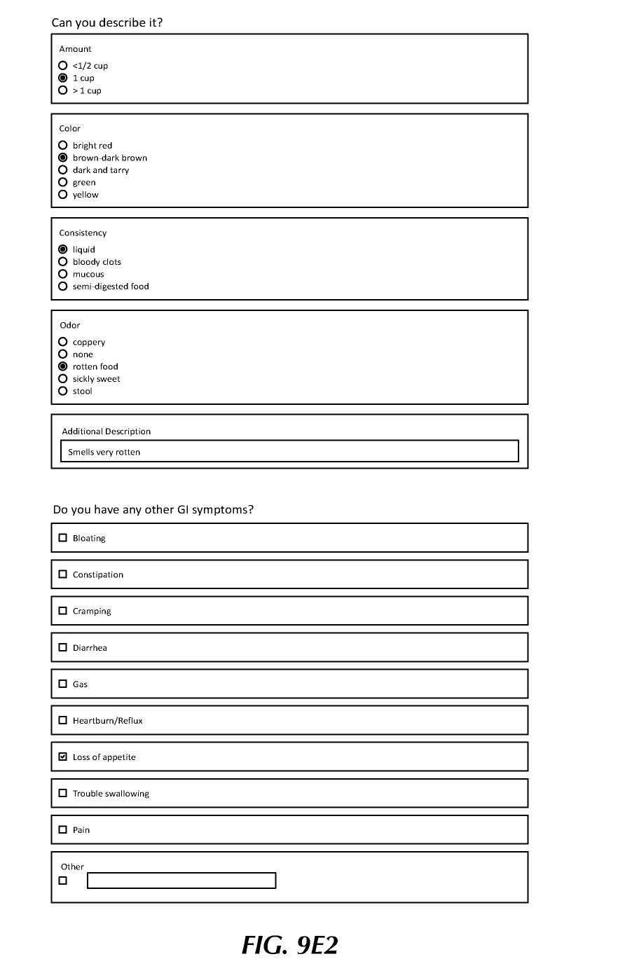

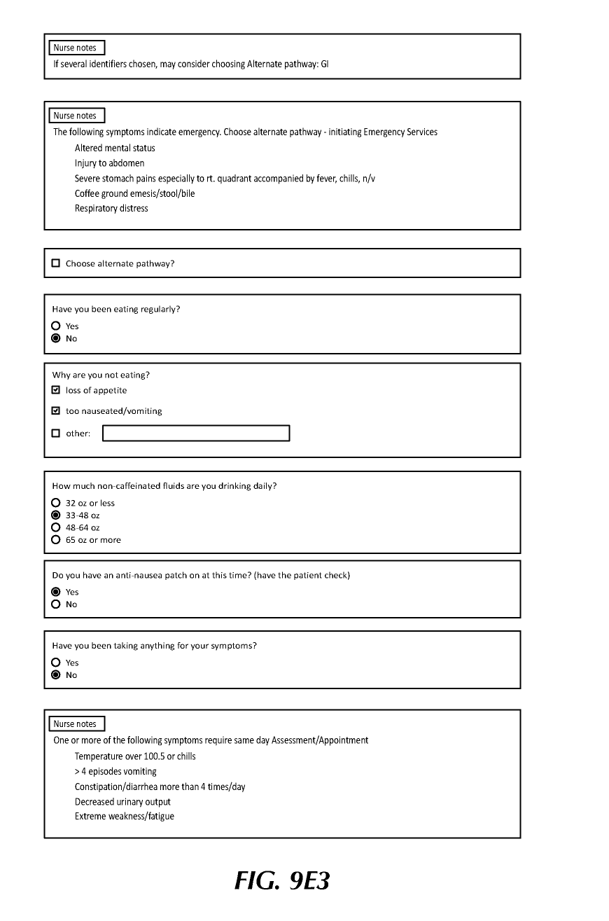

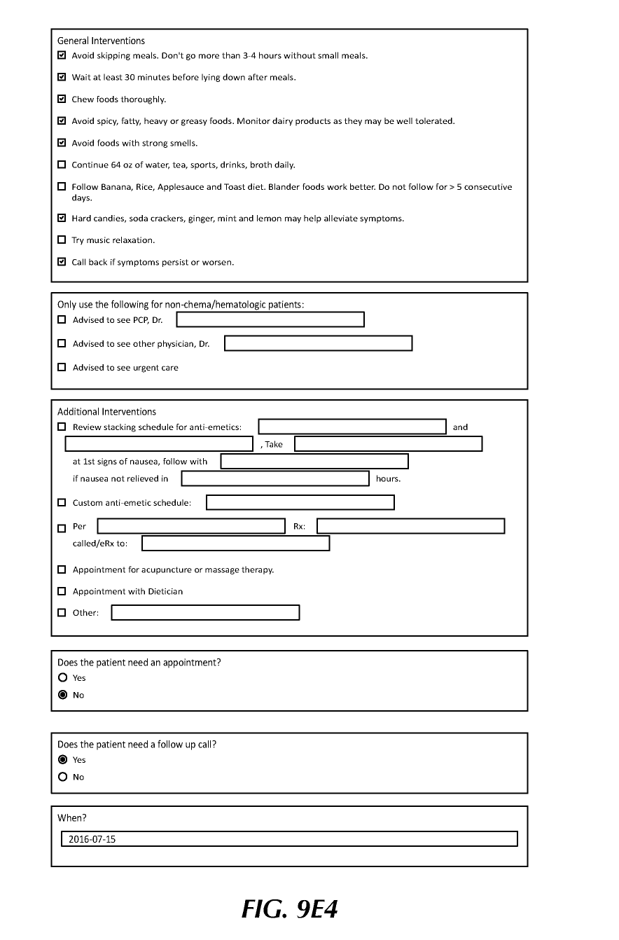

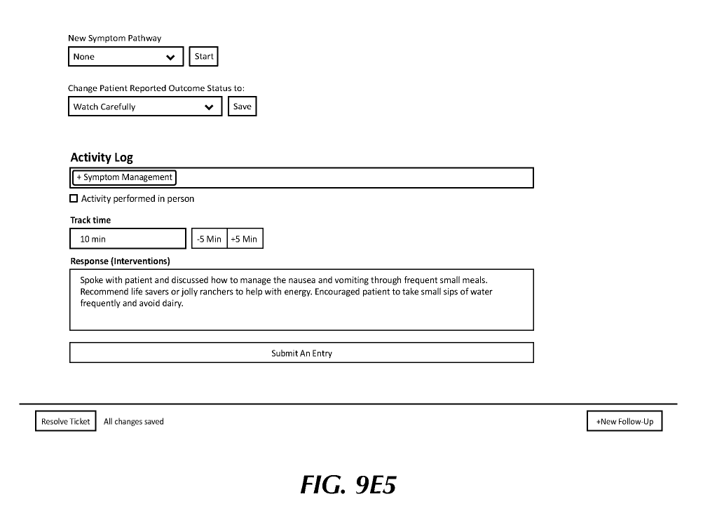

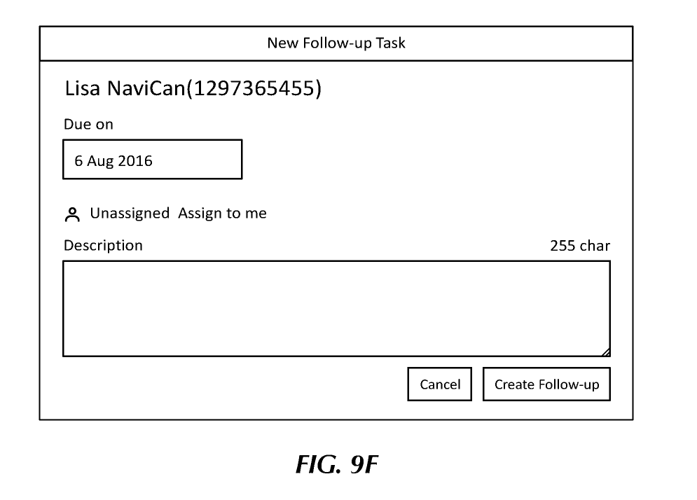

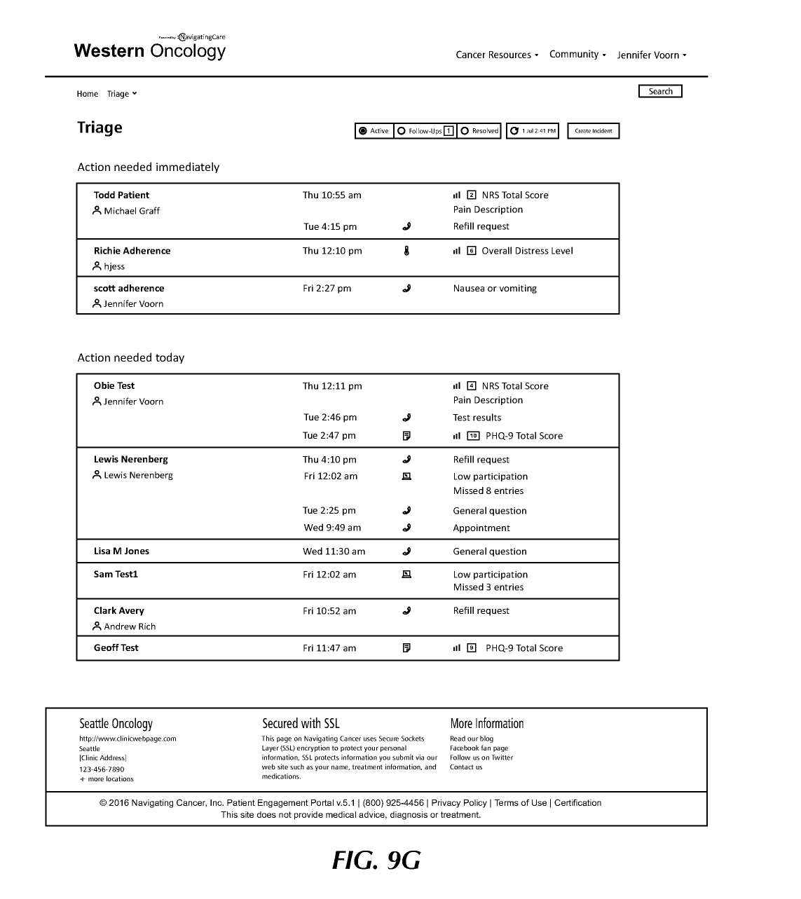

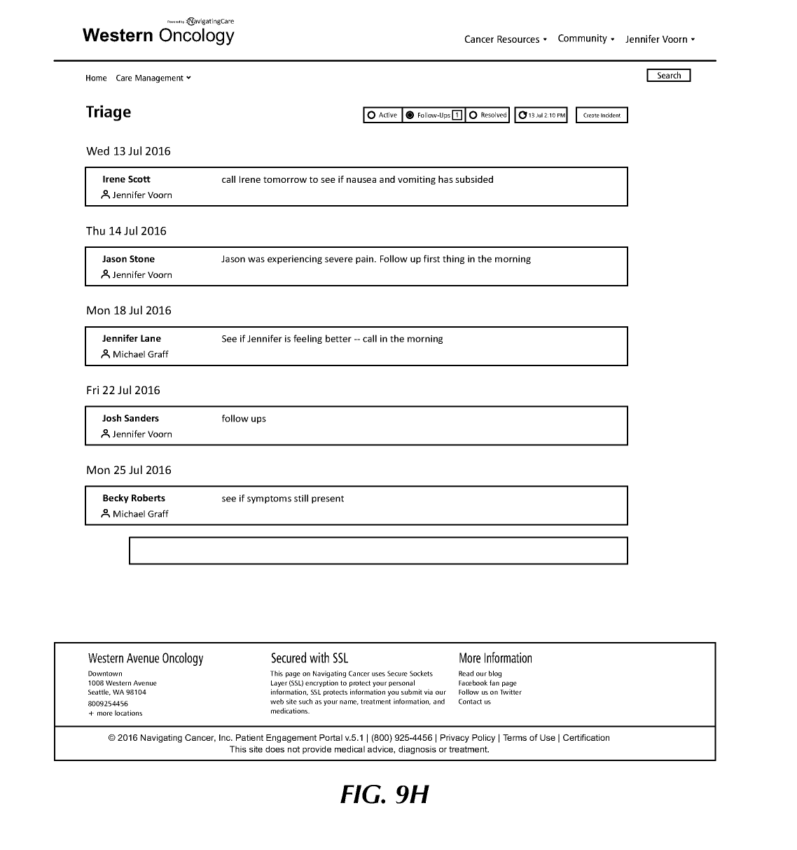

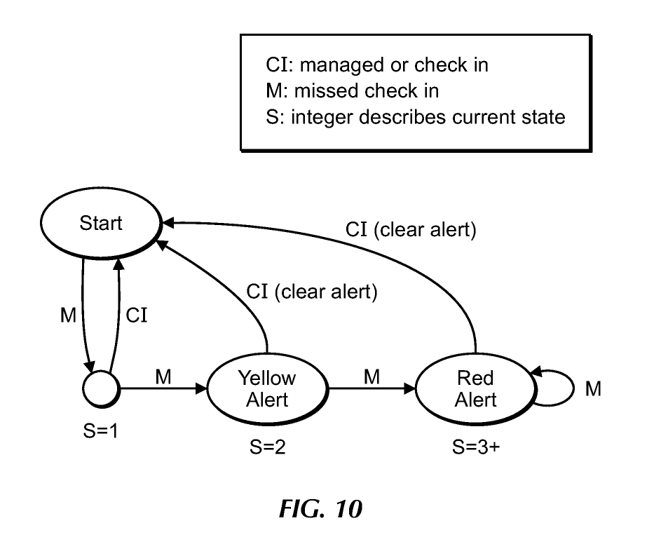

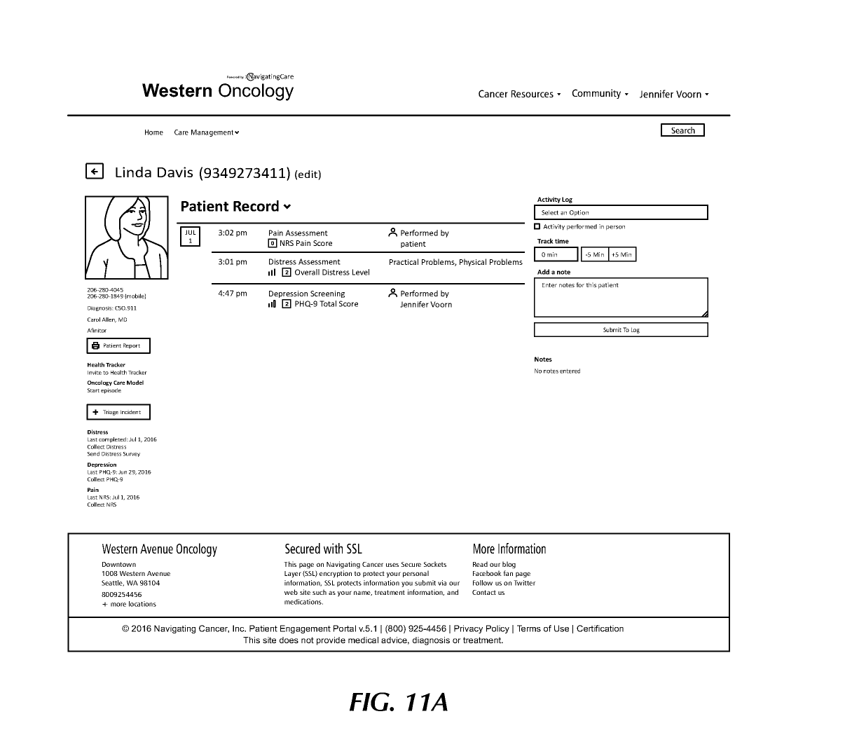

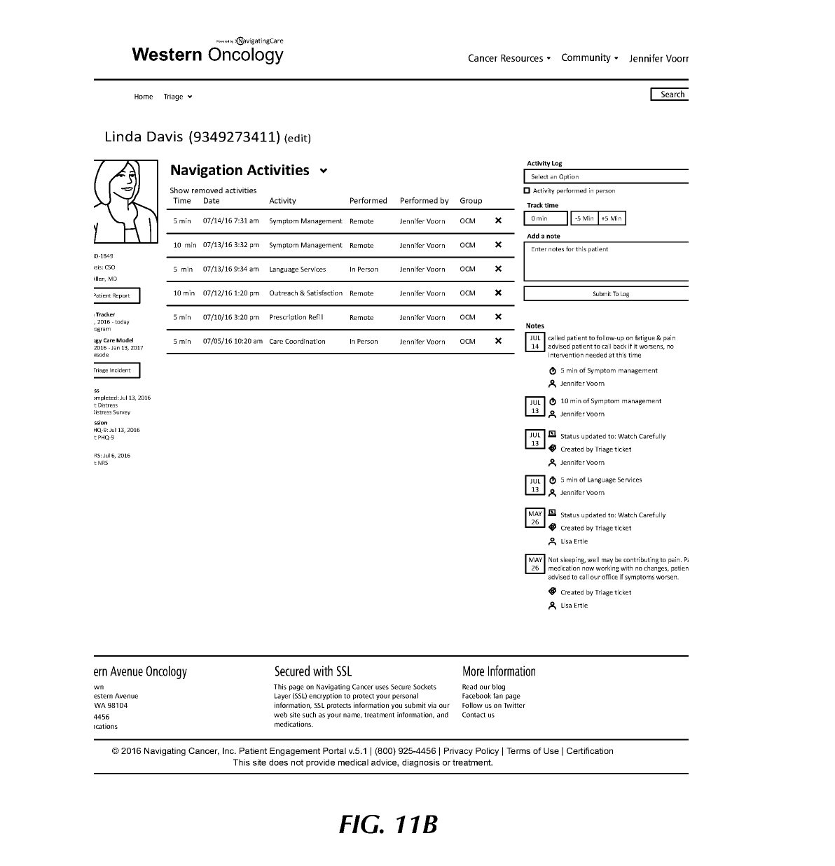

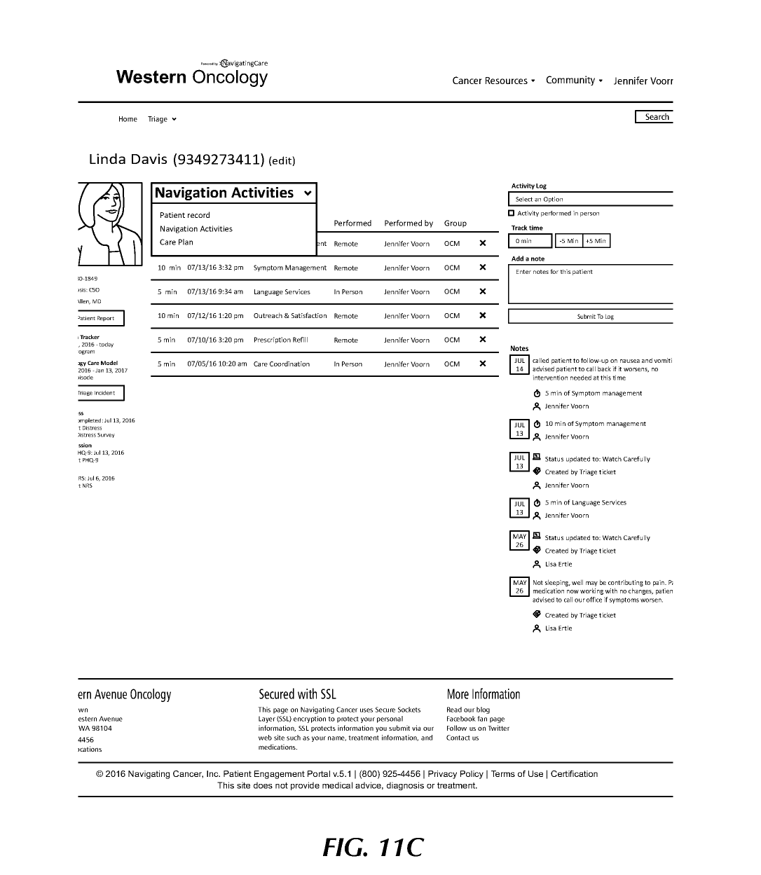

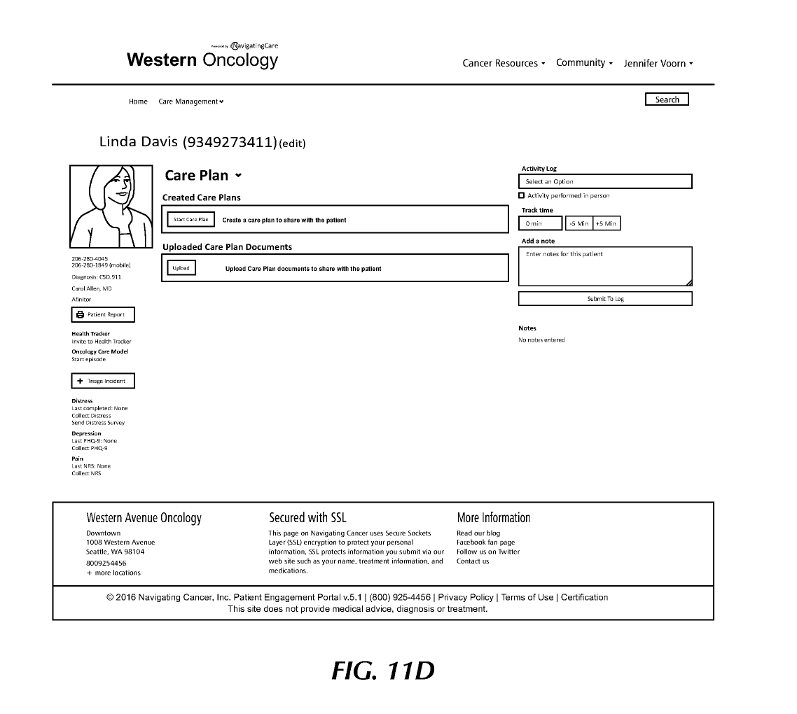

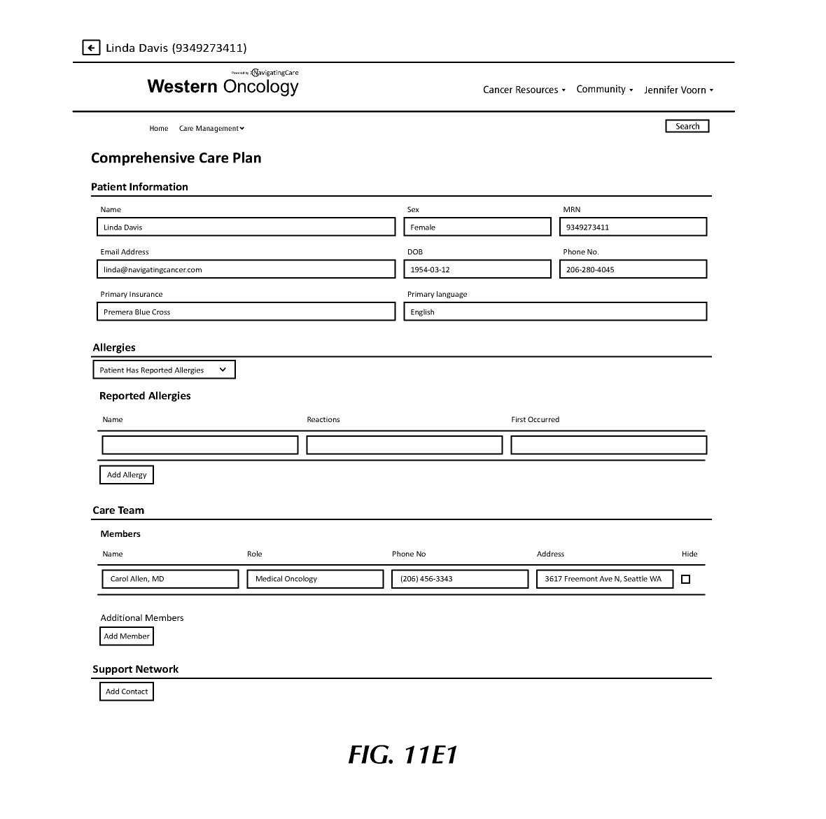

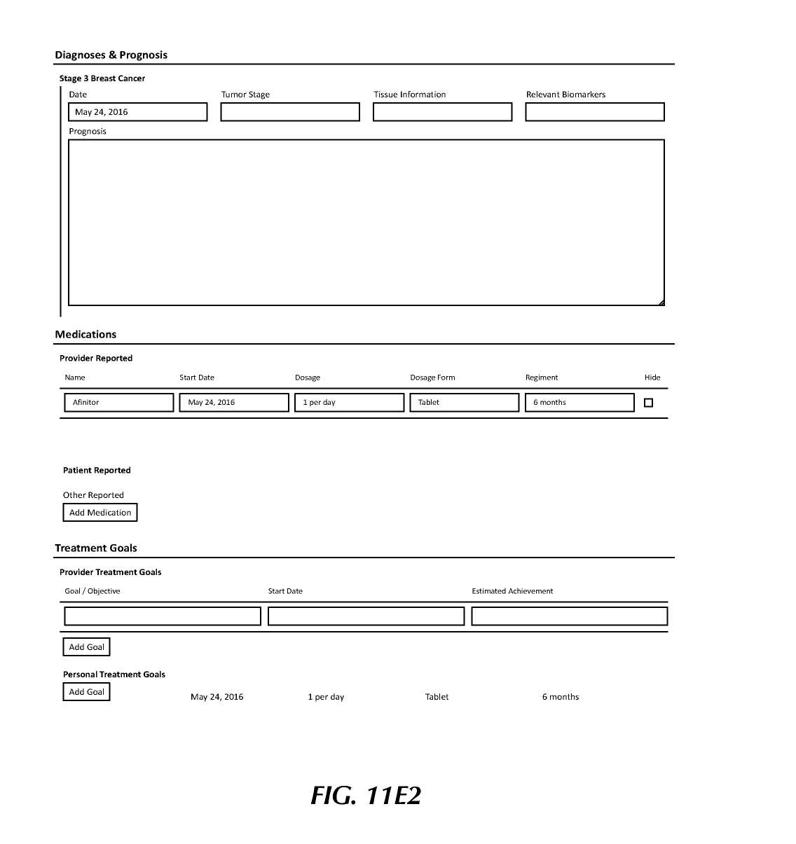

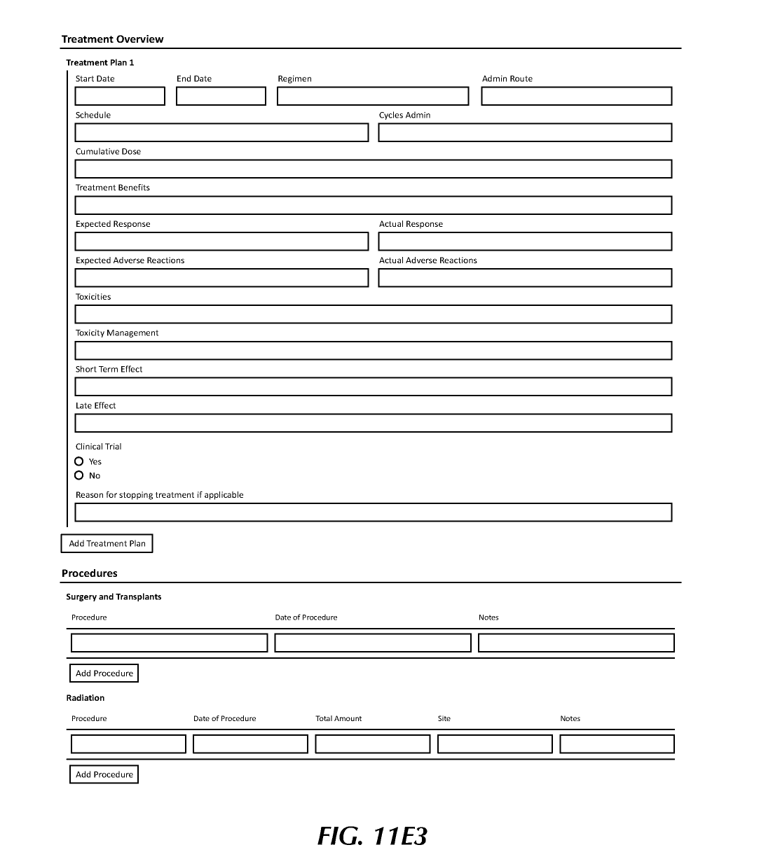

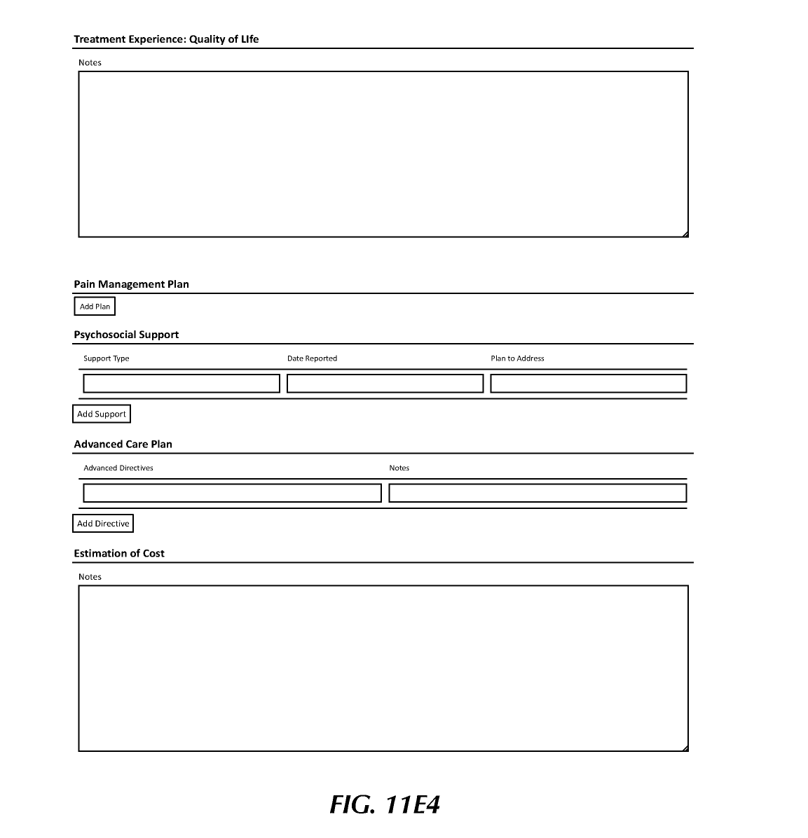

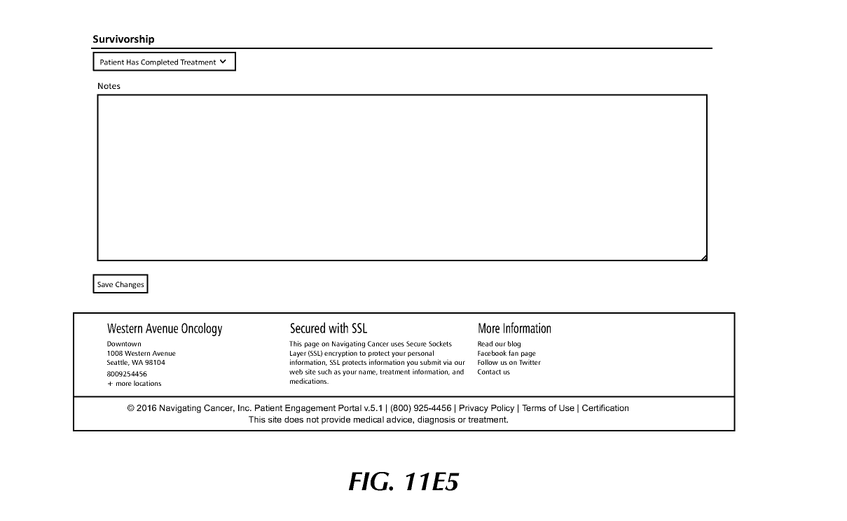

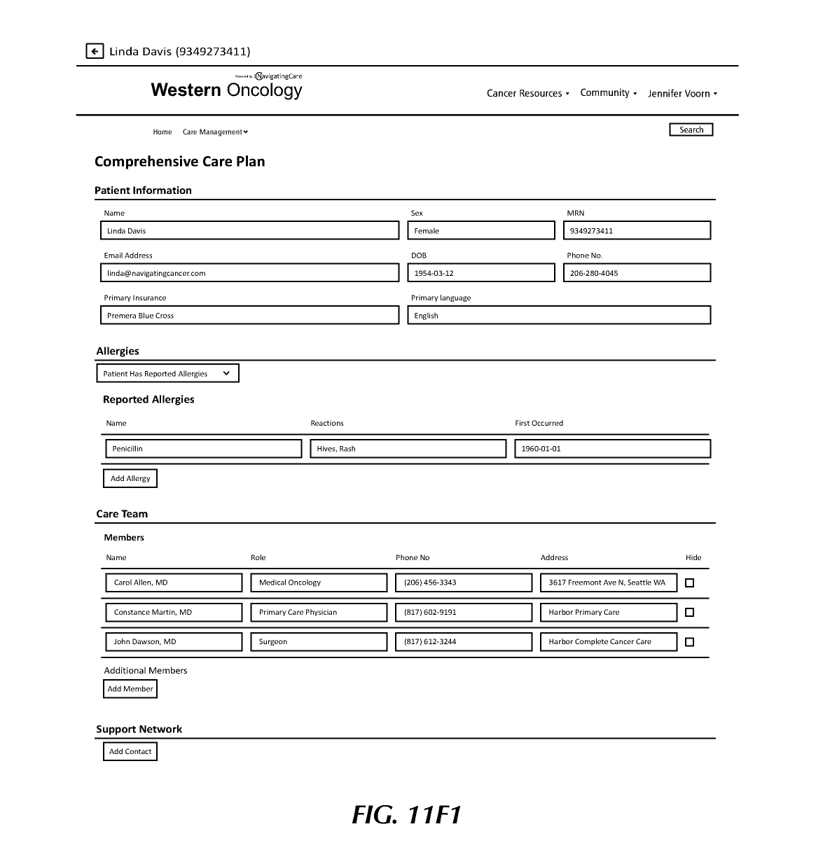

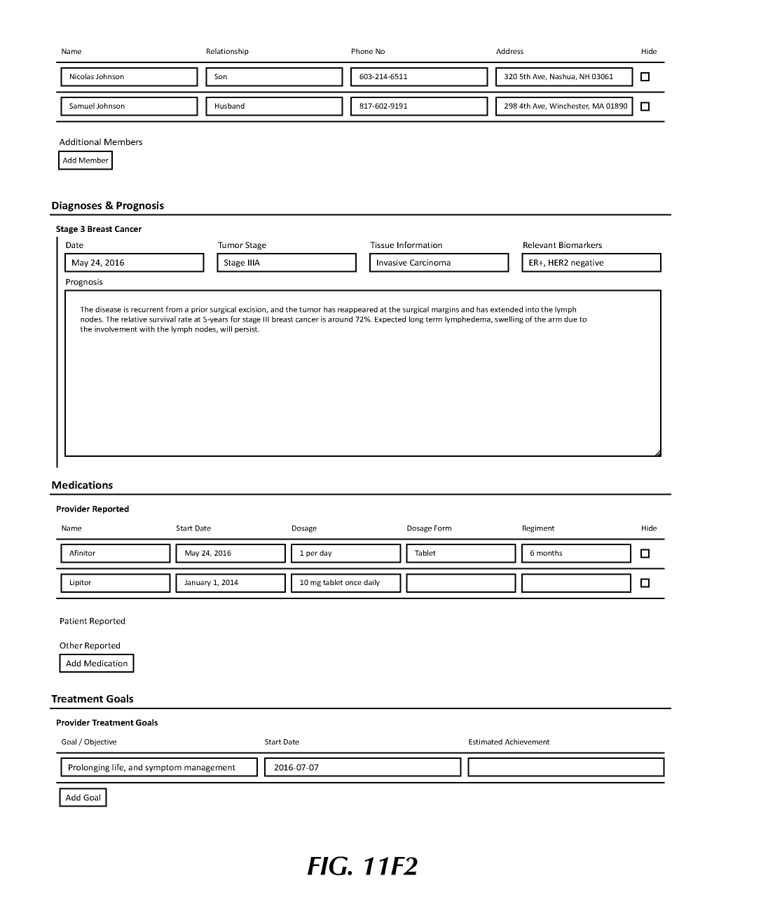

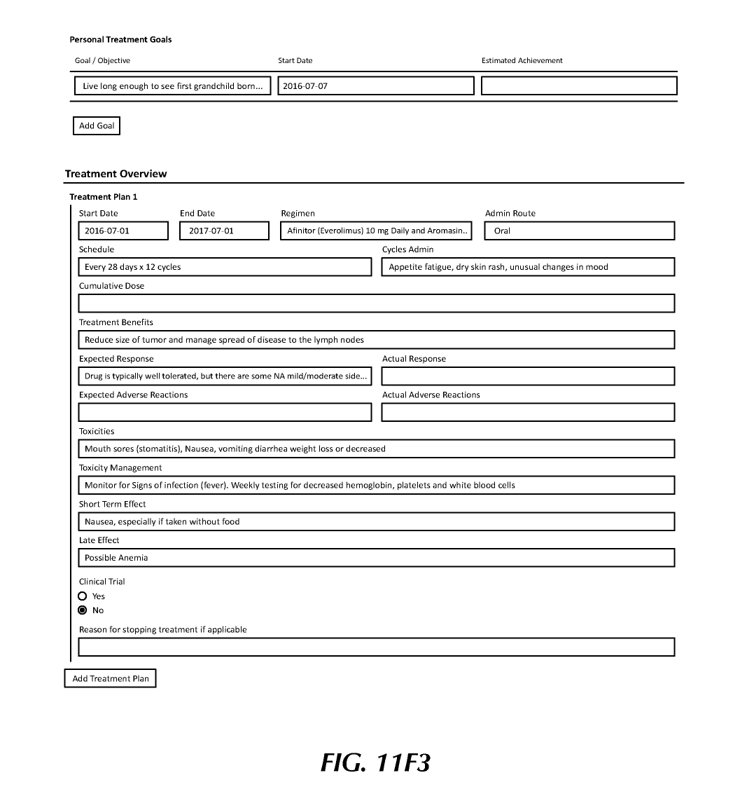

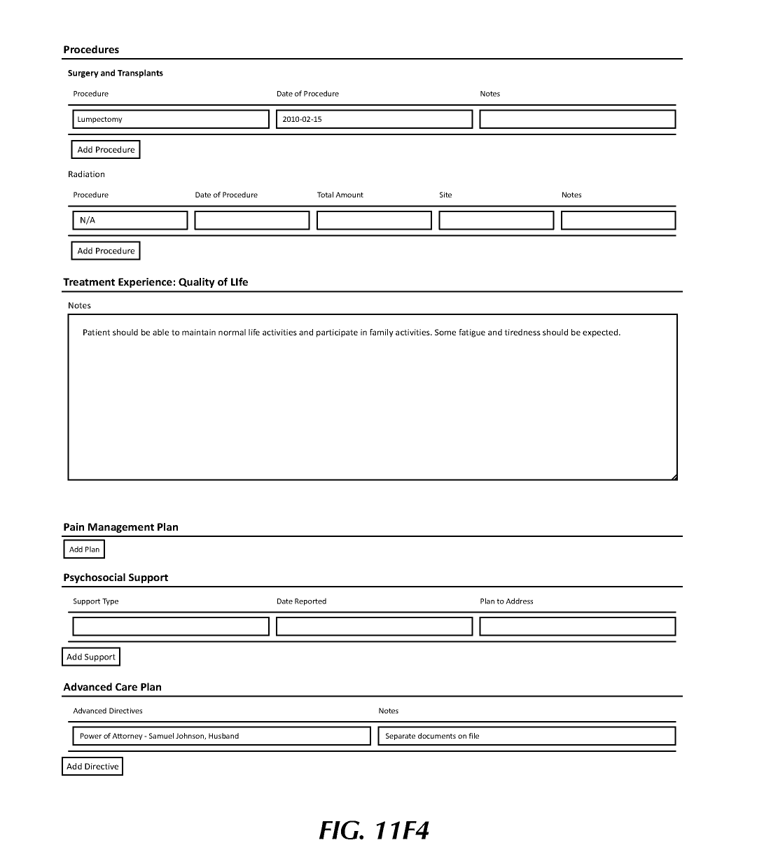

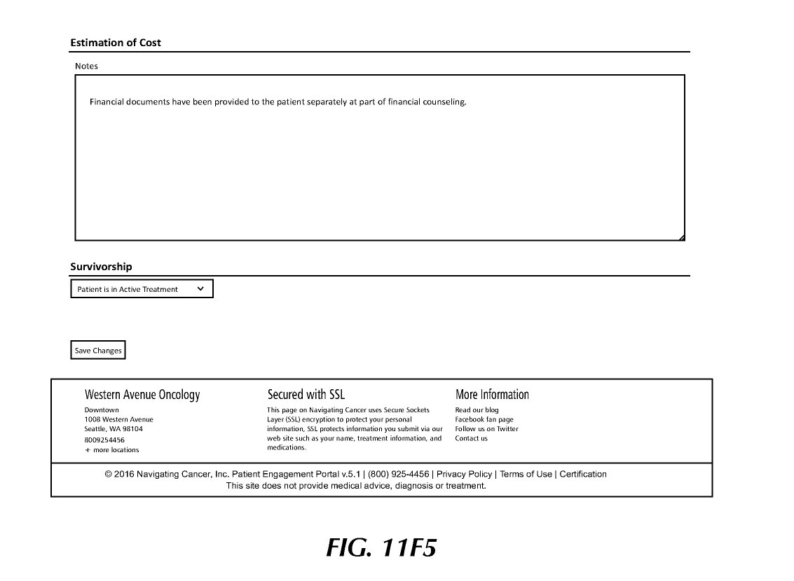

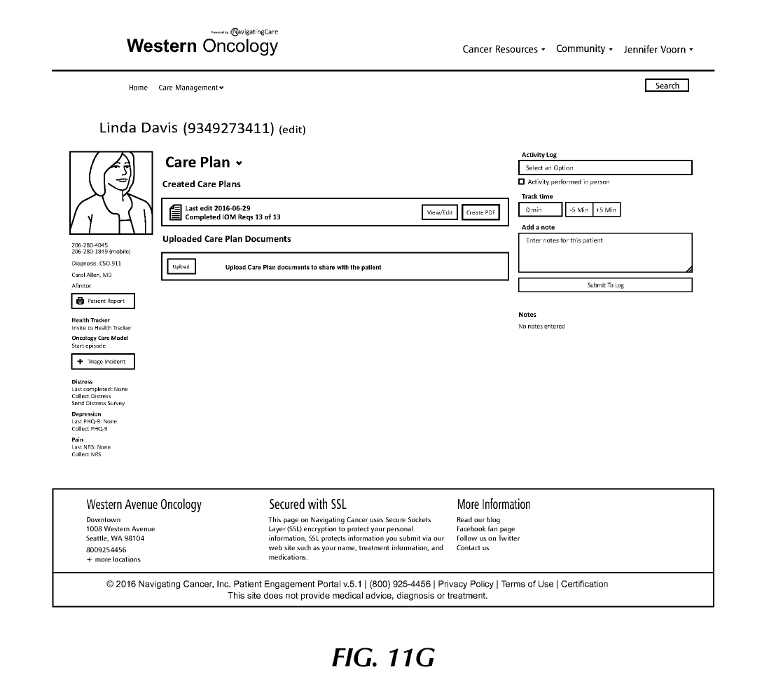

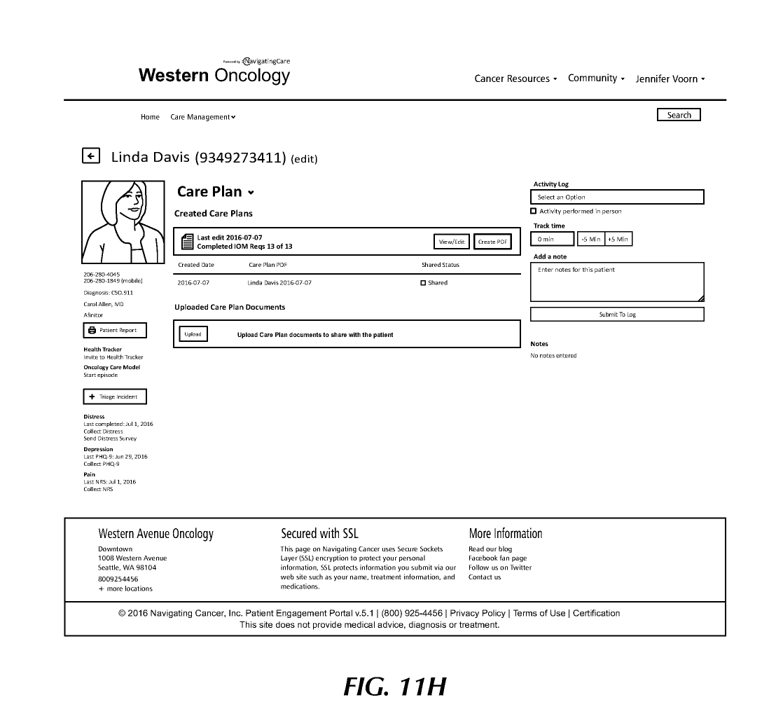

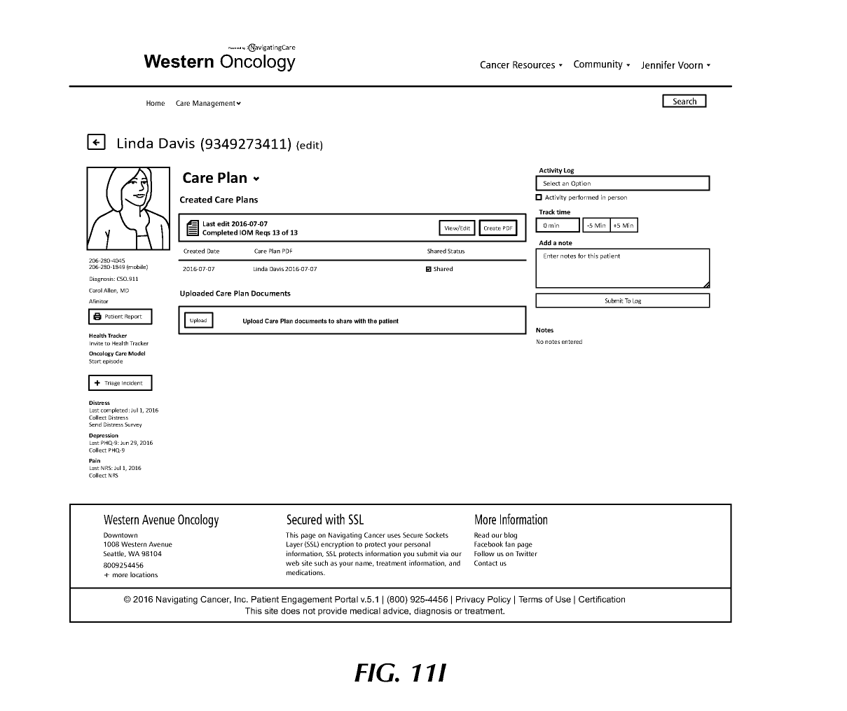

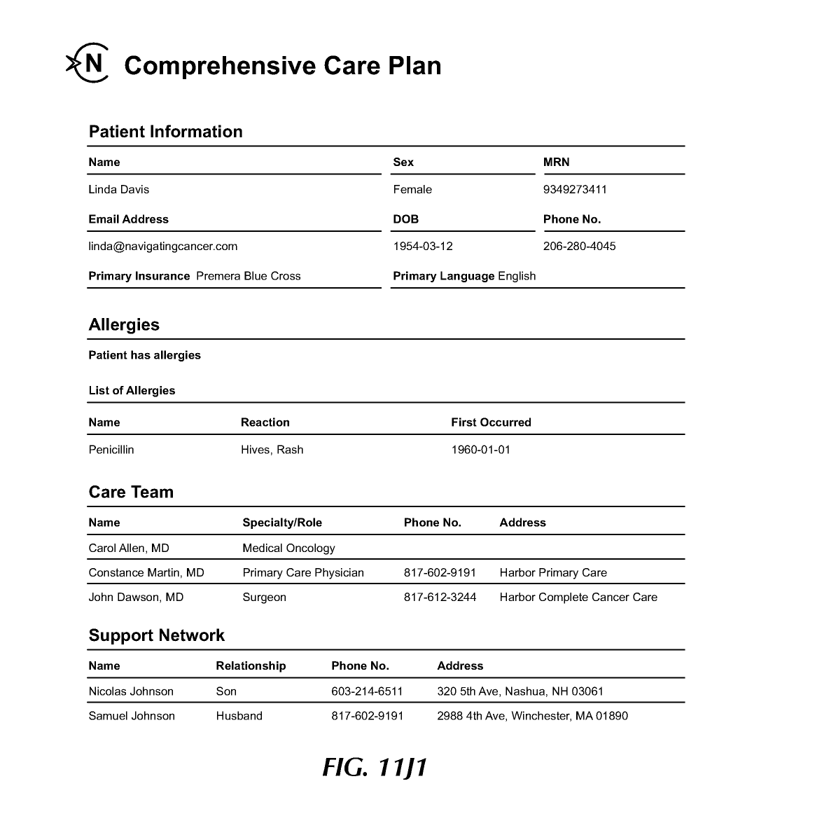

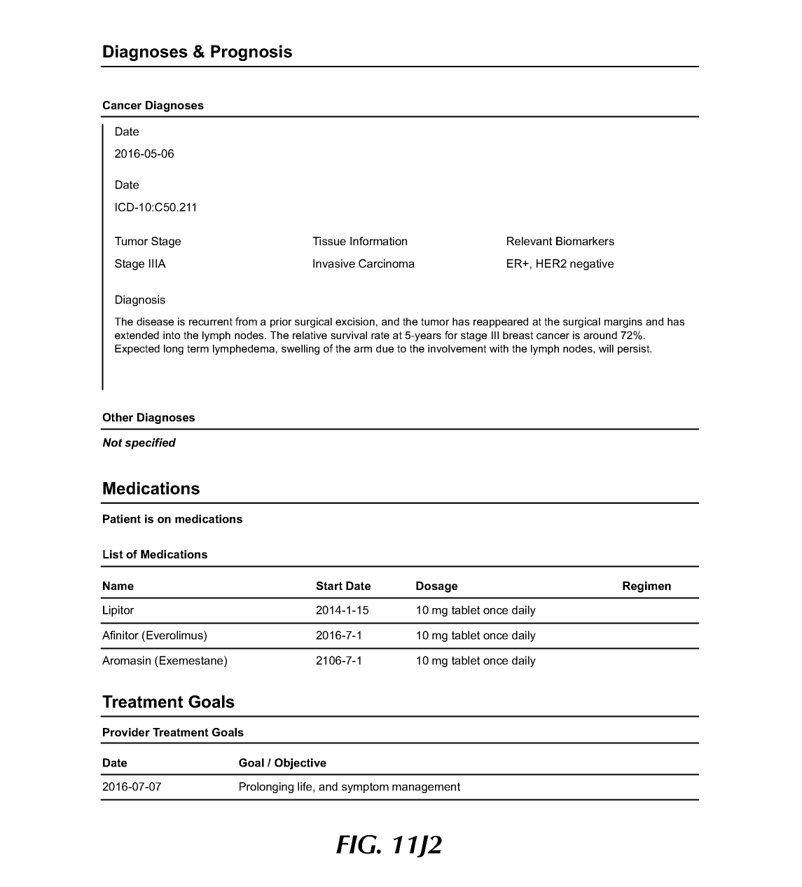

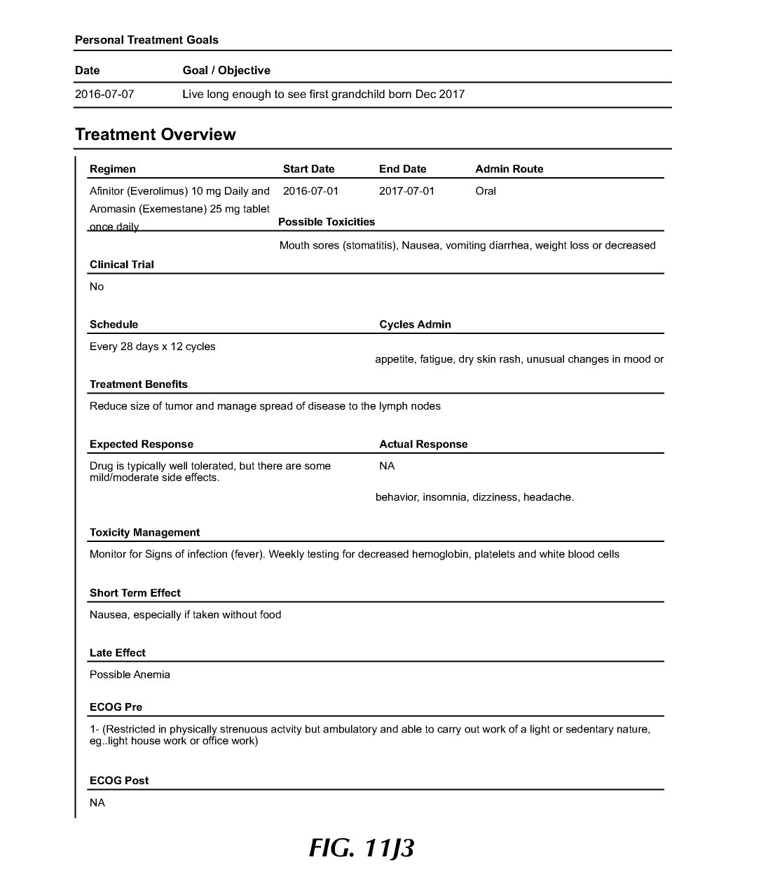

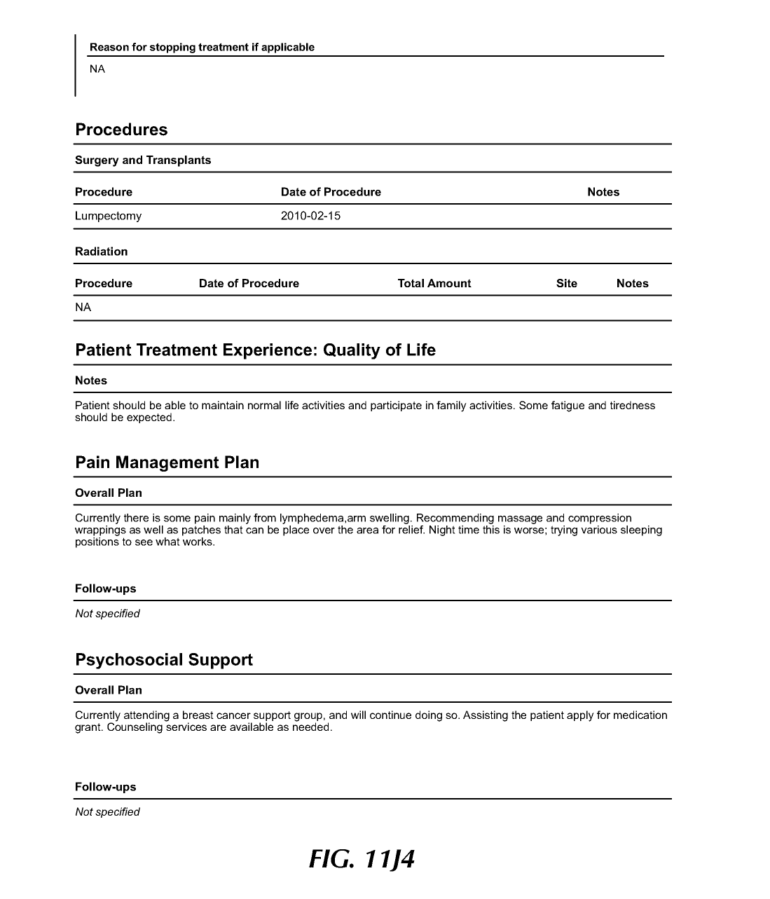

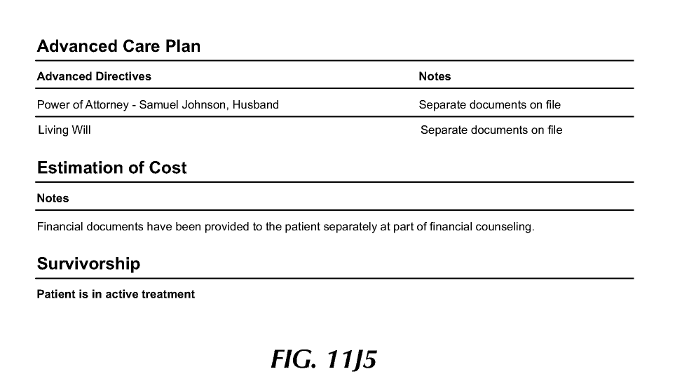

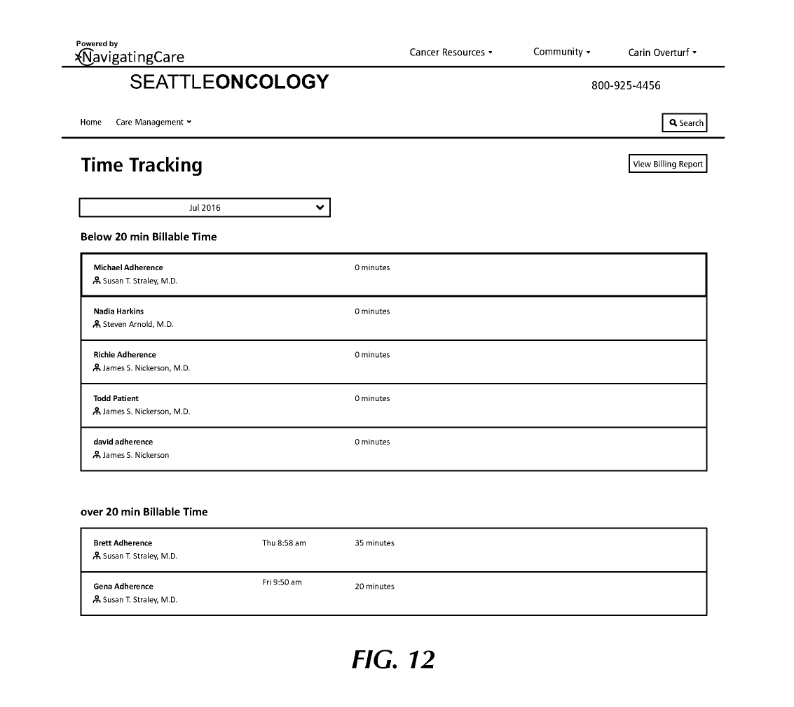

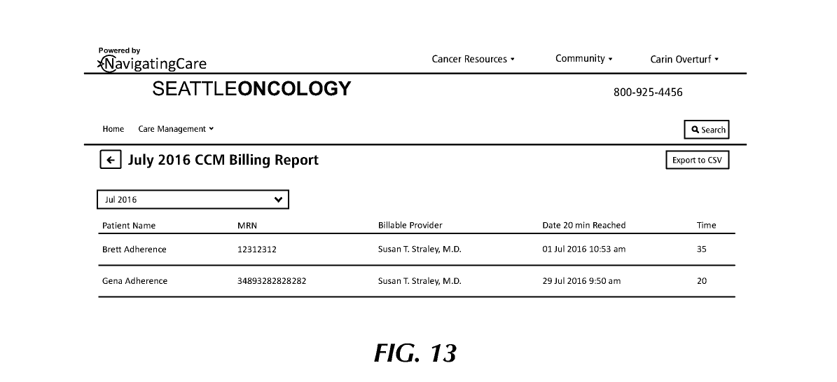

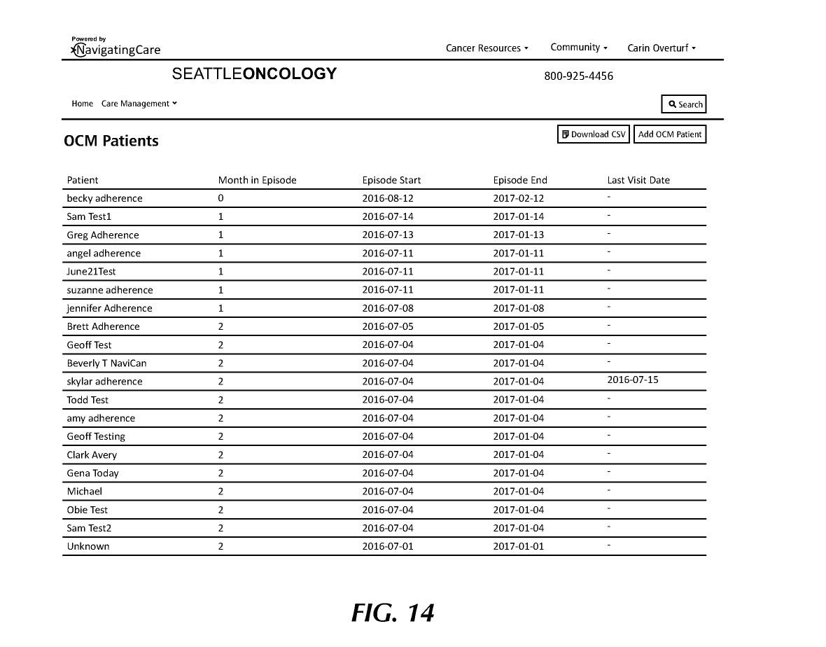

FIG. 6I is an example side effect severity “pain slider” (e.g., showing pain at level “2” on a “scale of 1-10”), under an embodiment.

FIG. 6J is an example side effect severity “pain slider” (e.g., showing pain at level “2” on a “scale of 1-10”) along with data indicating location of the pain (“pain is located in my lower stomach”), under an embodiment.

FIG. 6K is an example side effect severity (fatigue) reporting page, under an embodiment.

FIG. 6L is an example Summary page showing a summary of patient information reported during a daily check-in, under an embodiment.

FIG. 6M is an example completion page configured to generate a patient call request to the provider, under an embodiment.

FIG. 7A shows an example Patient Reported Outcomes Dashboard, under an embodiment.

FIG. 7B shows an example Patient Reported Outcomes Dashboard and selected patient panel (e.g., “Linda Davis”), under an embodiment.

FIG. 7C shows an example Patient Reported Outcomes Dashboard and selected patient panel (e.g., “Linda Davis”) with “Activity Log” and “note” data received at the dashboard, under an embodiment.

FIG. 8A shows conditions triggering Red Alerts (Action Needed) and Yellow Alerts (Watch Carefully) in the system for Standard (non-Elevated) patients, under an embodiment.

FIG. 8B shows conditions triggering Red Alerts (Action Needed) and Yellow Alerts (Watch Carefully) in the system for Elevated patients, under an embodiment.

FIG. 9A shows navigation via the “Care Management” menu from the Care Plan page of a patient (e.g., “Linda Davis”) to the Triage Dashboard, under an embodiment.

FIG. 9B shows an example Triage Dashboard including patients arranged by type (e.g., “Emergency”, “Action needed immediately”, “Action needed today”), under an embodiment.

FIG. 9C shows an example Triage Ticket of the Triage Dashboard for a selected patient (e.g., “Irene Scott”), under an embodiment.

FIG. 9D shows an example Manage Triage Ticket form of the Triage Dashboard for a selected patient (e.g., “Irene Scott”), under an embodiment.

FIGS. 9E1-5 show an example page of the Triage Dashboard configured to receive patient responses to queries and provide appropriate interventions, under an embodiment.

FIG. 9F shows an example Follow-up Task form of the Triage Dashboard, under an embodiment.

FIG. 9G shows an example Triage Dashboard following resolution of the event and patient removal, under an embodiment.

FIG. 9H shows an example Follow-up page of the Triage Dashboard, under an embodiment.

FIG. 10 is a flow diagram for operations involving a missed check-in by a patient, under an embodiment.

FIG. 11A shows an example Patient Record, under an embodiment.

FIG. 11B shows an example Navigation Activities section of the Patient Record, under an embodiment.

FIG. 11C shows an example Patient Record with the menu dropdown to select between “Patient Record”, “Navigation Activities”, and “Care Plan” sections, under an embodiment.

FIG. 11D shows an example Care Plan section of the Patient Record, under an embodiment.

FIGS. 11E1-5 show an example Patient Detail Page of the Patient Record, under an embodiment.

FIGS. 11F1-5 show an example filled Care Plan record, under an embodiment.

FIG. 11G shows an example Patient Record with Care Plan, under an embodiment.

FIG. 11H shows an example Patient Record with Care Plan, including Care Plan creation information and controls for sharing the Care Plan, under an embodiment.

FIG. 11I shows an example Patient Record with Care Plan, including Care Plan creation information and shared status information, under an embodiment.

FIGS. 11J1-5 show an example completed Care Plan record, under an embodiment.

FIG. 12 shows an example CCM Time Tracked Dashboard, under an embodiment.

FIG. 13 shows an example CCM Billing Report, under an embodiment.

FIG. 14 shows an example OCM Patients Dashboard, under an embodiment.

### DETAILED DESCRIPTION

Embodiments include one or more systems and processes for automated patient care management. A detailed description follows of system and process specifications as well as user interface specifications described in various example embodiments for care management. Embodiments described herein include one or more applications or components running on processors of one or more electronic devices, for example a personal computer, smart phone, tablet computer, or other personal computing device, that manage patient care including processing and managing patient care information or data. These components form a system for “care management,” also referred to herein as the “care management system”. The care management system or platform is configured to electronically exchange key clinical information between providers of care and patients and patient-authorized entities, as described in detail herein, and is a Health Information Technology for Economic and Clinical Health Act (HITECH) Meaningful Use stage 2 certified software as a service platform for oncology practices and their patients.

The patient care management platform described herein automates aspects of patient interaction and management, thereby automating and personalizing interactions and information exchange between patients and providers. The platform components include but are not limited to online patient registration, sharing of patient health records, automated patient education, secure messaging platform, automated side-effect tracking component, automated medication and appointment reminders, psychosocial support resources, and survivor care plans to name a few.

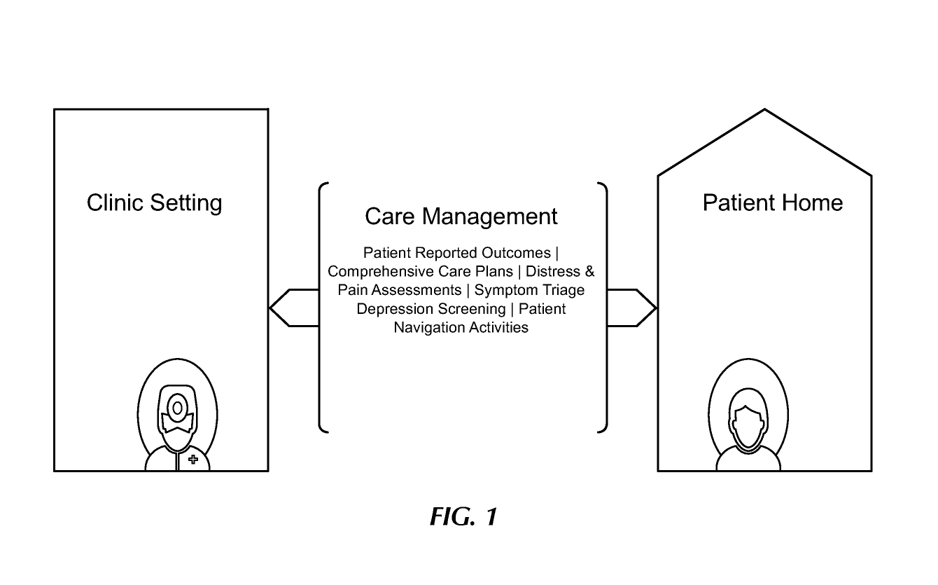

FIG. 1 is a block diagram of the care management system, under an embodiment. The care management system includes a system configured to collect and exchange data or information, including healthcare information, between a healthcare provider and a remote patient. Generally, the system includes a server-based or cloud-based platform coupled to a healthcare provider component and a patient component. The provider component includes a provider computer (e.g., server, personal computer, tablet computer, etc.) coupled to the platform via at least one of a care management application and a network or browser-based interface. Similarly, the patient component includes a patient computer (e.g., server, personal computer, tablet computer, smartphone, etc.) coupled to the platform via at least one of a care management application and a network or browser-based interface. Alternatively, when the patient does not have access to a patient computer, patient data or inputs are received via the provider component. The care management system of an embodiment is configured to exchange data with other electronic health record and/or healthcare provider systems but is not so limited.

The patient component includes for example a patient-friendly care management mobile application configured to execute on a smartphone or tablet computer (e.g., iPhone, iPad, Android device, Windows device, etc.), as described in detail herein. The mobile application engages patients through a daily text. This “check-in” is configured to boost adherence by reminding patients when its time to take their medication, and allowing them to record when they take the medication. It also prompts patients to enter how they are feeling on some regular (e.g., periodic, configurable) basis. Data are saved in one convenient location (at the platform), which patients are able to access throughout the course of their healthcare journey. For providers, these patient-reported outcomes can be monitored in real time through a care management dashboard.

In addition, the mobile application alerts healthcare providers when a patient should be contacted or watched carefully, facilitating a same-day patient-provider touch point that can avert or minimize hospitalizations. Providers can customize these alerts to be more or less sensitive to individual patients.

The provider component of the platform includes complex triage pathways configured to record and manage incoming calls and patient reported issues for consistency of care. Patient-reported outcomes components include real-time patient-reported outcomes that are risk-stratified enabling a provider to intervene with the patients in need more immediate care. Comprehensive care plans and survivor plans can be generated at the provider component and published to patients to ensure their participation and follow-up.

The provider component of the platform supports population care through its configuration to deploy automated programs for customizable populations to improve the quality and cost of care delivery. Patient use reporting includes automated interpretation of patient-utilization patterns to increase engagement in care. The provider is configured for review of reporting requirements for the OCM population of a provider, down to an individual provider and patient level. Providers are able to use the platform to gain unprecedented insights into patient behavior to generate tailored recommendations.

The platform includes a patient link supporting patient education, appointment schedules, intake and registration, patient portal, and meaningful use reporting. The patient education of an embodiment is configured to provide personalized education specific to individual patient diagnosis. Upcoming appointments can be automatically pulled directly from the provider practice management system. The platform is configured for remote collection of patient data, registration and consent prior to clinic visits. A patient portal of the platform is configured for patient access to their health records and secure messaging between the provider and the patient.

A patient component or application, which is coupled to the platform, includes a mobile healthcare tracker configured to send daily electronic (e.g., text) message reminders for patients to check in with their clinic regarding oral adherence and side effects. In generating distress assessments the patient component is configured to capture potential patient barriers to care beyond the clinic (e.g., physical, practical, emotional, spiritual, etc.). The patient component with the platform performs depression screening and follow-up, including initiating PHQ-9 depression screening and receiving real-time notification of elevated depression status for immediate intervention. Further, the patient component includes a pain assessment tool configured to perform pain assessment by evaluating pain intensity, duration and other factors that may contribute to overall pain.

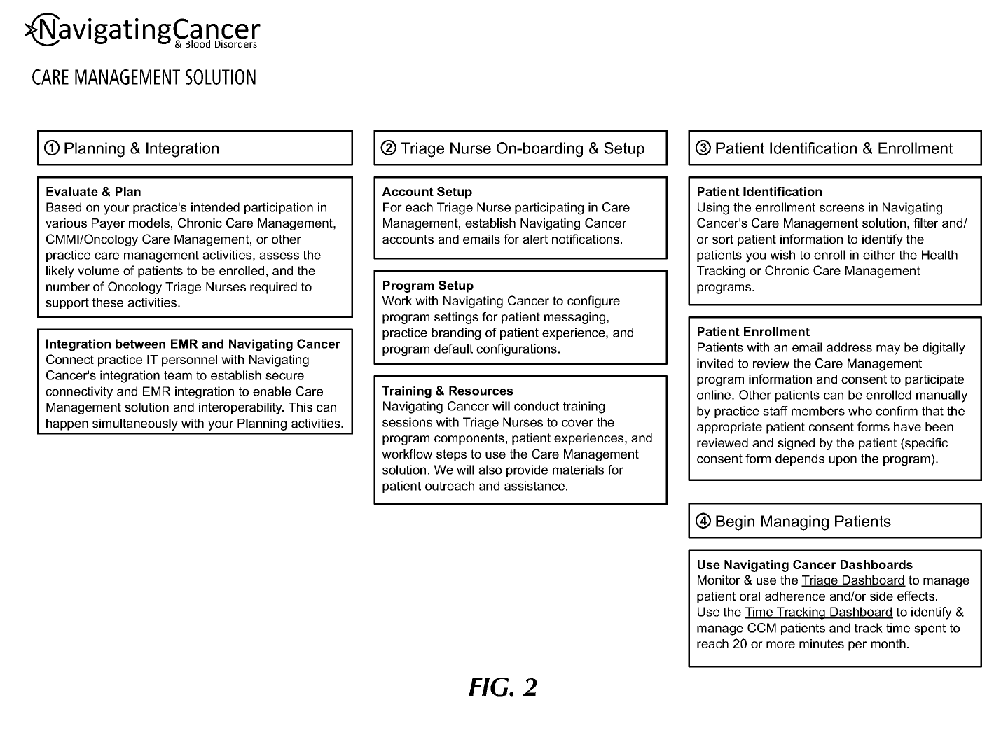

FIG. 2 is a flow diagram of the care management system or solution, under an embodiment. Generally, the system of an embodiment comprises two components (e.g., software programs, modules, applications, etc.) configured to exchange data between as follows:
1. Patient user experience includes a patient component (e.g., mobile application, portal, etc.) configured for use by a patient to report at least the following:
   a. Whether they took their cancer medication (referred to as “oral adherence”).
   b. Side effects they are experiencing from their cancer medication (often referred to as “patient-reported outcomes”).
2. Provider or clinic user experience includes a provider component (e.g., application, desktop web application, browser, portal, etc.) including or presenting a dashboard configured for use by provider staff members (e.g., triage nurse) to review and act on information reported by patients via the patient component.

The patient component is configured to capture the history of the patient's experience for historical purposes, and to provide a detailed record and view of patient responses and information entries throughout their enrollment in the care management program. The patient component is also configured to provide insights into the overall treatment side effect experience, oral adherence, and engagement in the care management program, as well as to provide demographic and contact information to assist the provider with managing and reaching out to the patient.

The provider component is configured to provide a dashboard by which the provider proactively manages patients enrolled in the care management program. The provider component enables a provider to understand “at a glance” if there is a new issue or patient that needs intervention and, as such, provides a one-stop view to understand how enrolled patients are adhering to their treatments and how they are doing related to medication side effects. Additionally, the provider component includes a triage list or “dashboard” of patients having side effects or oral adherence behavior that needs to be managed, and visually notifications to the healthcare team regarding patient check-in management. The provider component is configured to receive provider notations regarding patients and to track time pertaining to patient treatment.

The care management system of an embodiment comprises a system of components configured to collect information from patients via online and/or mobile software, and interact with a healthcare provider system in order to monitor the patient reported information to determine whether action or intervention in the patient's care is recommended. The system is configured to deliver a care management process comprising but not limited to the following:
1. Patient starts cancer treatment (oral or infused chemotherapy).
2. System triggers an enrollment request for the patient to start using the mobile “health tracker” application, based on appointment type, or life event (Chemo teaching, first appointment, reaching end of treatment, recurrence, change in treatment, etc.).
3. Clinics can also manually enroll patients in the program to monitor their patient-reported outcomes (PRO).
4. System schedules reminders that prompt patient to submit PRO and/or oral medication adherence, or distress:
   a. Schedule can be calendar based;
   b. medication cycle based;
   c. appointment based (n days before or after).
5. PRO/adherence/distress can be collected by:
   a. The patient using mobile device software.
   b. The patient, using a desktop web application.
   c. Healthcare Professional (HCP) on behalf of the patient (in person or on phone with patient).
6. Care management algorithm evaluates each PRO/adherence/distress submission against defined criteria to determine the resulting “alert” to be triggered for the healthcare team:
   a. Each patient submission (or by HCP on behalf of patient) is evaluated individually.
   b. Each patient submission (or by HCP on behalf of patient) is also evaluated relative to previous entries over time, to identify trends or patterns.
   c. Potential alerts/status' include:
      i. Contact now/action or intervention is needed.
      ii. Monitor, or watch patient carefully.
      iii. No action presently needed.
      iv. Patient not checked in, or have not started.
      v. Low participation relative to program settings/goals.
      vi. Low medication adherence relative to program settings/goals.
   d. Ability to assign alert sensitivity for individual patients (elevated alert levels) who need to be monitored more closely.
   e. Programs can include oral adherence, and/or patient-reported outcomes, and/or distress assessments.
7. HCP can record notes or indicate patient interactions and alter the patient alert/status level.
8. HCP can view each patient's detailed response history and all prior alerts and actions/notes entered by other provider staff members.
9. Participating patients can see a history of their entries and how their PRO/distress may relate to their medications/treatments received.

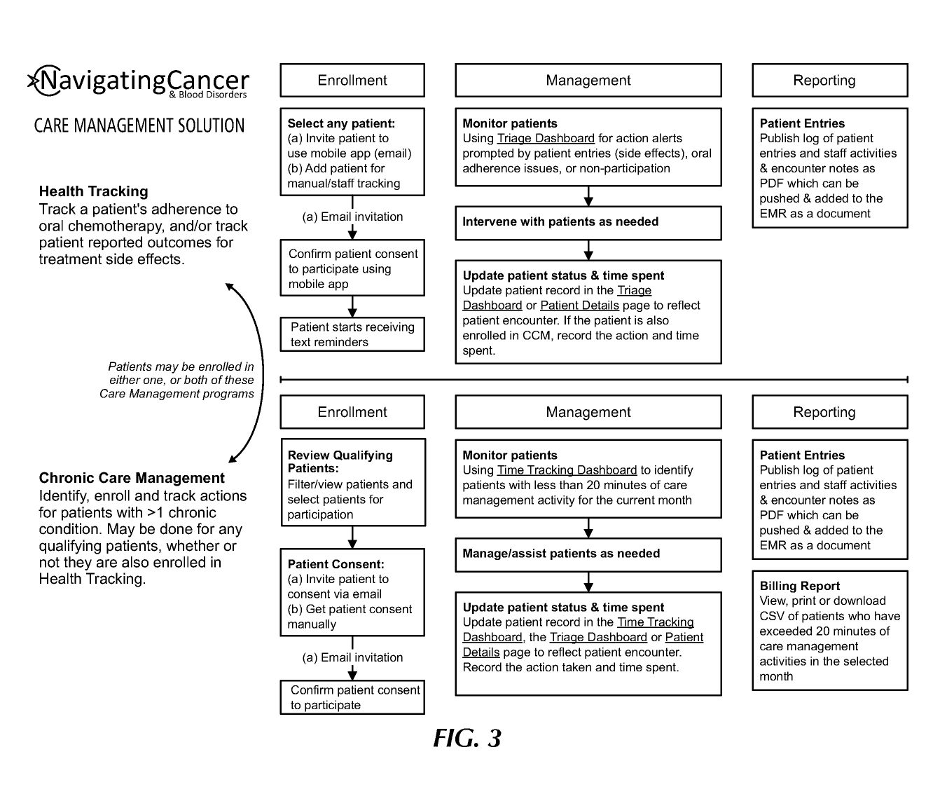

When a patient is identified as eligible for the care management program under the care management system or care management system embodiments herein, the patient is enrolled or registered in a program(s) appropriate to their condition and/or reported symptoms. The programs of an embodiment include a Health Tracker program (oral adherence and/or symptom tracker) and a Chronic Care Management (CCM) program, but are not so limited. FIG. 3 is a flow diagram of the Health Tracking and CCM programs, under an embodiment. The Care Management programs also include Oncology Care Model (OCM) episode programs as appropriate to the patient's condition and/or reported symptoms, but embodiments are not so limited. The care management system comprises numerous care management dashboards described in detail herein for use by healthcare providers (“providers”) in managing the care of enrolled patients. Each of these programs is described in detail below.

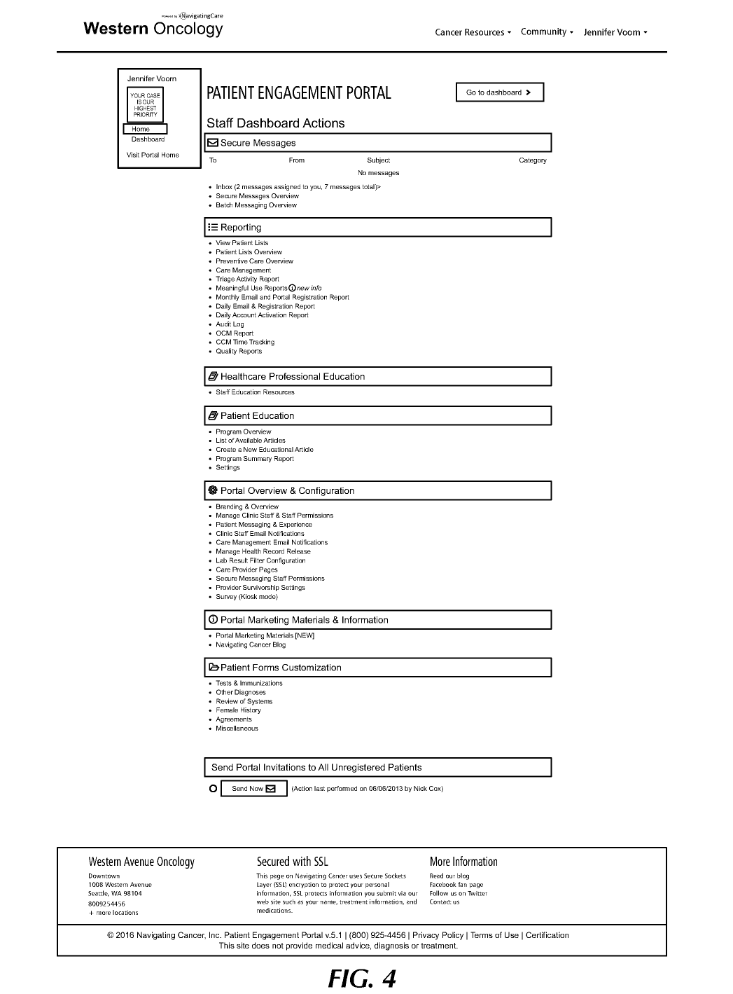

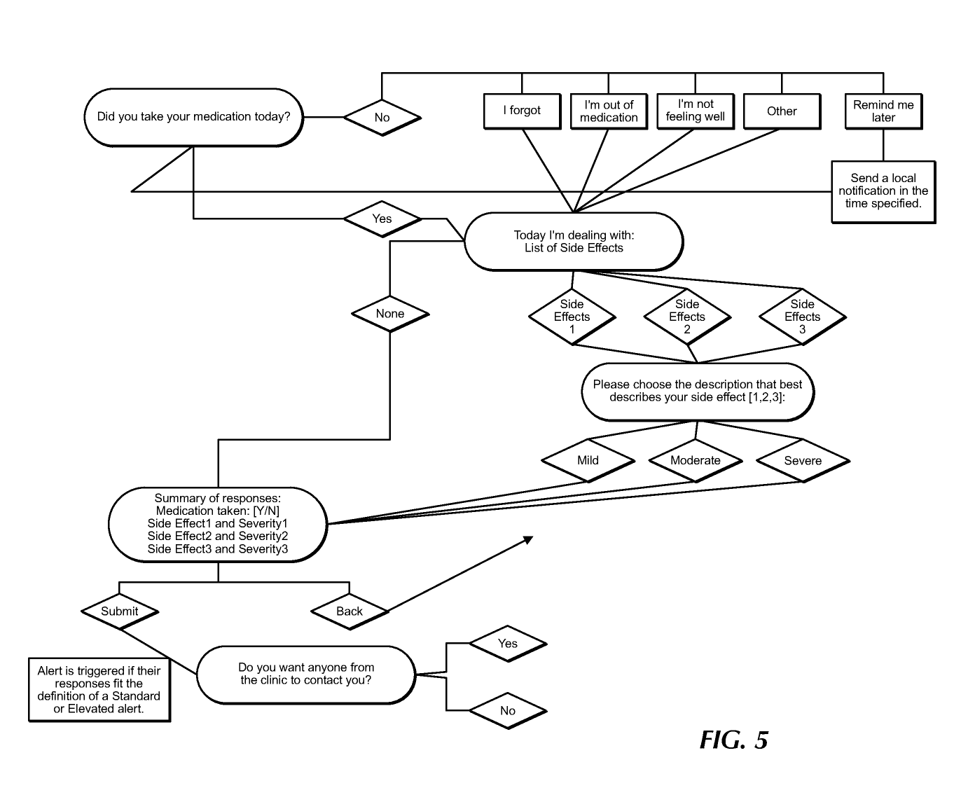

When a healthcare provider identifies a patient as a good candidate for the Health Tracker (e.g., starting an oral chemotherapy, an IV chemotherapy treatment, etc.), the provider reviews the program with the patient (e.g., in person, in the clinic, over the phone, during the patient's Chemotherapy Teaching, etc.). The provider confirms the patient has a phone or device (e.g., smartphone (iPhone, Android), tablet device, etc.) capable of receiving electronic messages (e.g., text messages, etc.) and instructs the patient to check into the program via their device or via a patient portal. The provider navigates to the Patient Engagement Portal and, from that portal or page, selects the patient's detailed page to provide or enter enrollment data in the Health Tracker program. FIG. 4 shows an example Patient Engagement Portal generated by the care management system, under an embodiment. An electronic enrollment form is configured to confirm the patient's email address, identify whether the patient condition is Elevated (and would therefore trigger more sensitive alerts from their patient reported outcomes), determine if the patient will be enrolled in only oral adherence tracking, only symptom tracking, or both oral and symptom tracking, create a schedule for the patient to receive a text message depending on their chemotherapy regimen, and determine the start date of the program.

Upon enrollment in the Health Tracker program, the patient name appears on one or more dashboards, including the Patient Reported Outcomes Dashboard (e.g., FIG. 7A). The care management system is configured to generate an email to the patient asking them to consent to enrollment in the Health Tracker program. If the patient has not yet registered for the patient portal, the care management system is configured to prompt the patient to do so through account creation.

Upon completing a log in event, patients are presented with a consent form indicating they are aware the program will send them a text message, their responses will not be continuously monitored, and advising they can opt out of the program at any time. After consenting (electronically) to the program, the patient selects a time of day they wish to receive their message (e.g., text or SMS) and a phone number to which the message is to be sent. On the specified program start date, the care management system is configured to send a patient a first text message prompting whether they took their medication and/or if they have been experiencing any adverse symptoms in response to the medication.

Patients participating in the Health Tracker program report their health status on a regular basis. The schedule of the patient reporting is configurable by the provider, and can be customized to match a patient's medication schedule or as directed by the provider. The results of the patient reporting, which is accomplished remotely via the patient component (e.g., smartphone application, etc.) and/or a patient portal configured to capture or receive data, are compiled in the Health Tracker as described in detail herein. FIG. 5 is a flow diagram for patient reporting of the patient component, under an embodiment. FIGS. 6A-6M show an example of patient reporting pages of the patient component, under an embodiment.

FIG. 6A is an example daily check-in page for medication consumption reporting, under an embodiment. This medication check-in is not presented to a patient not taking an oral therapy, under an embodiment. FIG. 6B is an example daily check-in page for additional medication information reporting, under an embodiment. FIG. 6C is an example of a general side effects reporting page, under an embodiment. The general reporting page(s) is configured to receive information on whether or not a patient is experiencing any side effects or adverse reactions. If side effects are reported, the Health Tracker includes additional page(s) configured to receive information on particular side effects being experienced. For example, information of side effects or adverse reactions of an embodiment includes but is not limited to one or more of the following: a new or increasing pain; nausea or vomiting; mouth sores or sensitivity (mucositis/stomatitis); fatigue (energy level decreasing); diarrhea; rash; signs of infection; cough; swelling (arms, legs, hands, feet) (edema); constipation; difficulty breathing (dyspnea); dehydration (dizzy, light-headed, increasing thirst, decreased urination); fever, chills, infection (fever, chills, cough, burning when urinating); free-form patient entry.

FIGS. 6D-6G are example side effects details pages, under an embodiment.

More particularly, FIG. 6D is an example side effects reporting page including a list of prevalent side effects, under an embodiment. FIG. 6E is an example side effects reporting page including relatively more comprehensive list of side effects, under an embodiment. FIG. 6F is an example side effects reporting page on which one side effect (“A new or increasing pain”) is selected, under an embodiment. FIG. 6G is an example side effects reporting page on which two side effects (“A new or increasing pain” and “Fatigue”) are selected, under an embodiment.

In response to information of side effects received from the patient via the Health Tracker, additional reporting pages corresponding to the reported side effect(s) are generated and presented to the patient via the patient component. The additional reporting pages are configured to gather from the patient more detailed information of each reported side effect. FIG. 6H is an example side effect severity (pain) reporting page, under an embodiment. The side effect severity (pain) reporting page includes selectors or indicators configured to receive information of side effect(s). For example, the side effect severity (pain) reporting page of an embodiment includes a “pain slider” configured to receive and indicate information of pain severity, and a data entry block to receive data input regarding location of the pain. FIG. 6I is an example side effect severity “pain slider” (e.g., showing pain at level “2” on a “scale of 1-10”), under an embodiment. FIG. 6J is an example side effect severity “pain slider” (e.g., showing pain at level “2” on a “scale of 1-10”) along with data indicating location of the pain (“pain is located in my lower stomach”), under an embodiment.

FIG. 6K is an example side effect severity (fatigue) reporting page, under an embodiment. FIG. 6L is an example Summary page showing a summary of patient information reported during a daily check-in, under an embodiment. FIG. 6M is an example completion page configured to generate a patient call request to the provider, under an embodiment.

The Health Tracker processes information or data of side effects received at the Health Tracker via patient reporting (e.g., smartphone application, patient portal, call-in, etc.) in order to automatically classify the side effects as “mild”, “moderate”, or “severe”. As described in detail herein, the side effect classification is one factor configured to control patient alerts for coding patient conditions. The patient alerts include standard alerts for non-Elevated patients, and elevated alerts for Elevated patients.

The standard alerts comprise “yellow alerts” (watch carefully), which are triggered by moderate side effects. Yellow alerts are also triggered by at least one of the following patient-reported factors: no patient check-ins for two (2) consecutive days; medication adherence is “no” for two (2) of the last five (5) patient check-ins; patient status updated; low patient participation (e.g., less than 50%) for a pre-specified period (e.g., 14 days into program); patient reporting treatment paused by doctor.

The standard alerts also include “red alerts” (action needed), which are triggered by severe side effects. Red alerts are also triggered by at least one of the following patient-reported factors: medication adherence is “no” for three (3) of the last five (5) patient check-ins; no patient check-ins for three (3) consecutive days; patient reporting out of medication; patient requesting a call by provider; patient requesting pain management.

The elevated alerts comprise “yellow alerts” (watch carefully), which are triggered by mild side effects. Yellow alerts are also triggered by at least one of the following patient-reported factors: no patient check-ins for one (1) consecutive day; patient status updated; patient reporting treatment paused by doctor.

The elevated alerts also include “red alerts” (contact now), which are triggered by moderate side effects. Red alerts are also triggered by at least one of the following patient-reported factors: medication adherence is “no”; no patient check-ins for two (2) consecutive days; patient reporting out of medication; patient requesting a call by provider; low patient participation (e.g., less than 75%) for a pre-specified period (e.g., 14 days into program); patient requesting pain management.

The Health Tracker of an embodiment is configured to process patient reported side effect information to classify the reported effects as “mild”, “moderate”, or “severe”. A general side effect reported by the patient as “your energy level decreasing”, depending on severity, is classified as one of “mild” (“I've noticed my energy decreasing slightly, but I can recover with rest.”), “moderate” (“I've noticed my energy decreasing, and I am not able to recover with rest. It has slightly limited by daily routine.”), or “severe” (“I am severely fatigued and am not relieved by rest. My fatigue has interfered with my daily routine.”).

A general side effect reported by the patient as “breathing becoming more difficult”, depending on severity, is classified as one of “mild” (“I've noticed an increase in shortness of breath, but I can walk one flight of stairs without stopping.”), “moderate” (“I'm getting short of breath more often, which has slightly limited by daily routine.”), or “severe” (“I'm getting short of breath easily or it is painful to breath, sometimes while resting. It has interfered with my daily routine.”).

A general side effect reported by the patient as “increased pain”, depending on severity, is classified as one of “mild” (“I have mild pain, but it is not interfering with daily activities.”), “moderate” (“I have moderate pain, and the pain, or pain medication, is interfering with some daily activities.”), or “severe” (“I have severe pain, and the pain, or pain medication, is severely limiting daily activities.”).

A general side effect reported by the patient as “diarrhea”, depending on severity, is classified as one of “mild” (“I have a small increase in loose stools per day, up to 1-4.”), “moderate” (“I have moderate increase in loose stools per day, up to 4-6, but it is not limiting my daily routine.”), or “severe” (“I'm lacking control of my bowels or more than 7 loose stools per day. It has not subsided, despite treatment and I am feeling weak, dizzy, pain or cramping.”).

A general side effect reported by the patient as “constipation”, depending on severity, is classified as one of “mild” (“I have occasional or intermittent symptoms. I have been occasionally using stool softeners, laxatives, dietary modification, or enema.”), “moderate” (“I have persistent symptoms, even with using laxatives or enemas. It is limiting some of my daily routine.”), or “severe” (“I have had severe constipation for more than 2 days, even after using laxatives or enemas. It has not subsided and I am not able to perform my daily routine.”).

A general side effect reported by the patient as “nausea or vomiting”, depending on severity, is classified as one of “mild” (“I've lost my appetite, but have not really changed my eating habits. I might have vomited 1-2 times in the past 24 hours.”), “moderate” (“I've lost my appetite, but have not lost much weight. I might have vomited 3-5 times in the last 24 hours, but I'm not dehydrated or malnourished.”), or “severe” (“I'm so nauseous that I have not eaten so I've lost weight, feel dehydrated, weak, or malnourished. My urine is much darker. I might have vomited 6 or more times in the last 24 hours.”).

A general side effect reported by the patient as “swelling of your arms, legs, hands or feet”, depending on severity, is classified as one of “mild” (“I have noticed slight swelling in my arms, legs, hands, or feet, but it has not altered the shape.”), “moderate” (“I have noticed a swollen area noticeably larger than normal, limiting some daily activities.”), or “severe” (“I have swollen arms, legs, hands, or feet that are much larger than normal. It has severely limited daily activities.”).

A general side effect reported by the patient as “rash”, depending on severity, is classified as one of “mild” (“I have subtle changes on my skin, like redness or itching, but it is not painful.”), “moderate” (“I have peeling, slight oozing, blisters, bleeding, or swelling on my skin, maybe with some pain, but it is not limiting my daily routine.”), or “severe” (“I have sores on my skin that are painful or oozing. They are interfering with my daily routine.”).

A general side effect reported by the patient as “mouth sores or sensitivity”, depending on severity, is classified as one of “mild” (“My mouth or throat has slight skin changes or redness, but I'm not feeling any pain.”), “moderate” (“My mouth or throat is sensitive and it might be difficult to swallow or eat, but I have not changed my eating habits.”), or “severe” (“My mouth or throat is sensitive and it is difficult to swallow or eat. I see white patches in my mouth or throat.”).

A general side effect reported by the patient as “cough”, depending on severity, is classified as one of “mild” (“I have a persistent cough, but it is not affecting my daily routine.”), “moderate” (“I have a persistent cough that is slightly limiting my daily routine.”), or “severe” (“I have a severe cough that is interfering with my daily routine.”).

A general side effect reported by the patient as “dizzy, light-headed, increasingly thirsty, decreased urination”, depending on severity, is classified as one of “mild” (“I am more thirsty than normal, but I have been urinating les. I might also be feeling slightly dizzy or light-headed, but it hasn't affected my daily routine.”), “moderate” (“I am a lot more thirsty than normal, but urinating noticeably less often. I might also be dizzy or light-headed, which is slightly limiting my daily routine.”), or “severe” (“I am much more thirsty than normal, but urinating very infrequently. I might also be very dizzy or light-headed which has severely interfered with my daily routine.”).

A general side effect reported by the patient as “fever, chills, cough, burning when urinating”, depending on severity, is classified as one of “mild” (“I have some abdominal pain or lost my appetite, but it has not affected my daily activities. I might be urinating slightly more often, up to twice as often.”), “moderate” (“I have a slight fever of 99-100 degrees or moderate abdominal pain. My eating habits have changed, limiting my daily activities. I might be urinating more often, but not more than twice in an hour.”), or “severe” (“I have a fever of 101 degrees or severe abdominal pain that has stopped me from my daily routine. I might also have a pain or burning sensation when urinating.”).

Patient information received by the care management system is available and presented to a corresponding healthcare provider via the provider component of the system. FIG. 7A shows an example Patient Reported Outcomes Dashboard, under an embodiment. The Patient Reported Outcomes Dashboard is configured for proactive management of patients enrolled in the Health Tracker and, as such, includes a list of active Health Tracker patients in order to monitor any trending adherence issues or adverse symptoms. This dashboard also presents patient data represented by data entered via the patient component based on the level of alert triggered by the data entered. The Patient Reported Outcomes Dashboard also includes a list of Health Tracker patients who have been opted out or completed their Health Tracker program. The Patient Reported Outcomes Dashboard is configured to provide patient monitoring in Watch Carefully in order to prevent them moving into Action Needed where acute care is required.

Selection of a patient on the Patient Reported Outcomes Dashboard causes a panel to be displayed corresponding to the selected patient. FIG. 7B shows an example Patient Reported Outcomes Dashboard and selected patient panel (e.g., “Linda Davis”), under an embodiment. The patient panel is configured to receive data on patient activity (e.g., “Activity Log”), receive notes pertaining to the patient (e.g., “Add a note”), and receive data of time spent on patient care activity (e.g., “Track time”), but is not limited to these tasks. FIG. 7C shows an example Patient Reported Outcomes Dashboard and selected patient panel (e.g., “Linda Davis”) with “Activity Log” and “note” data received at the dashboard, under an embodiment.

The care management system is configured to enable editing of a patient's Health Tracker settings at any time to change phone number, time of day to receive a text message, and/or change patient status to Elevated. Furthermore, the system can opt a patient out of Health Tracker and at any time from the Edit Settings page so that the patient no longer receive text messages and is moved into the “Opted Out” section of the Patient Reported Outcomes page. A Health Tracker program for a patient can be completed from the Edit Settings page at any time so that the patient no longer receives text messages and is moved into the “Completed Therapy” section of the Patient Reported Outcomes page. The system is configured to Pause or Resume a Health Tracker program at any time from the Edit Setting page so that the patient no longer receives an oral adherence prompt if they are taking a break from their chemotherapy as symptoms clear up.

The care management system is configured to manage Health Tracker patients and to prompt patients (e.g., text message) as scheduled regarding medications, appointments, and data of conditions, to name a few. The system includes “yellow alerts” (watch carefully) and “red alerts” (action needed) for coding patient conditions. Generally, yellow alerts are configured to identify to the provider patients who are potentially heading toward an Action Needed (red alert) state so that the provider might be able to mitigate and proactively manage. FIG. 8A shows conditions triggering Red Alerts (Action Needed) and Yellow Alerts (Watch Carefully) in the system for Standard (non-Elevated) patients, under an embodiment. FIG. 8B shows conditions triggering Red Alerts (Action Needed) and Yellow Alerts (Watch Carefully) in the system for Elevated patients, under an embodiment. The various coded alerts (e.g., red, yellow, etc.) can be used to control one or more characteristics of the dashboards described herein, for example, information of a patient corresponding to a red alert can be presented using fonts having different characteristics (e.g., color (e.g., red font corresponds to red alert, etc.), size, type, position, placement, etc.).

The care management system places patients having conditions that trigger a yellow alert in a Watch Carefully section on the Patient Reported Outcomes Dashboard. These patients do not persist in the Watch Carefully section, but instead have their current placement on the Patient Reported Outcomes Dashboard updated as appropriate to their conditions on a next subsequent check-in. A Triage Ticket is not created for a yellow alert but embodiments are not so limited. When managing a patient out of “Watch Carefully”, Navigation Activities are tracked, if applicable.

Patients coded with red alerts need to be managed or they will continue to stay, unmanaged, in the appropriate section. The care management system places patients having conditions that trigger a red alert in an Action Needed section on the Patient Reported Outcomes Dashboard, and also automatically creates a new Triage Ticket that appears on the Triage Dashboard (e.g., see FIGS. 9A-9H) in the “Action Needed Today” section. To manage a patient, a provider opens the Triage Ticket in the system provider component and initiates a Symptom Pathway. The patient is queried regarding their condition, the patient responses are recorded or entered into the system, and appropriate interventions are provided. The current status of the patient is updated by selecting a status from the “Updated status” menu in order to move the patient out of “Action Needed” and into the appropriate section on the Patient Reported Outcomes Dashboard. The system is configured to track Navigation Activities, if applicable. The provider creates a Follow-up task in the system in order to set up a reminder to follow up with the patient to confirm their symptoms have subsided. The Triage Ticket is resolved to create a record (e.g., PDF) of the patient interaction, and the patient is removed from the Triage Dashboard and moved out of “Action Needed” on the Patient Reported Outcomes Dashboard.

The care management system is configured to manage triage patients and is configured to include the Triage Dashboard for management of these patients. The Triage Dashboard is configured for reactive management of patients who have called into a health care provider, triggered a red alert from their Health Tracker check-in, and/or triggered a red alert from a survey, as described in detail herein. The Triage Dashboard presents a list of patients with acute care needs, prioritized into sections by urgency of the need, and helps a healthcare provider to work through the list of Triage Tickets by the end of the day and address all acute care needs for patients in a timely manner. FIGS. 9A-9H show pages of the Triage Dashboard, under an embodiment.

In response to a call from a patient reporting a need to speak to a clinical nurse, the operator navigates to the Triage Dashboard and searches for the patient in order to open a new Triage Incident. FIG. 9A shows navigation via the “Care Management” menu from the Care Plan page of a patient (e.g., “Linda Davis”) to the Triage Dashboard, under an embodiment. FIG. 9B shows an example Triage Dashboard including patients arranged by type (e.g., “Emergency”, “Action needed immediately”, “Action needed today”), under an embodiment. Selection of a patient on the Triage Dashboard causes a panel to display the selected patient's information including any open Triage Tickets. A Triage Ticket for the patient is opened and any open incidents that exist for the patient are presented. FIG. 9C shows an example Triage Ticket of the Triage Dashboard for a selected patient (e.g., “Irene Scott”), under an embodiment. The call back name and phone number of the patient are recorded along with the reason for the call and any additional details. Depending on the reason selected for the call, the patient can move into the appropriate section of the Triage Dashboard: Emergency, Action needed immediately, Action needed today. The operator can increase or decrease the urgency by selecting the appropriate urgency section. The care management system is configured to track Navigation Activities, if applicable. The operator creates the incident, and the Triage Ticket appears on the Triage Dashboard with the new incident information.

The Triage Ticket can be managed from the new incident form or from the Triage Dashboard. The operator selects “Manage Triage Ticket” to open the Manage Triage Ticket form, and contacts the patient to assess their triage needs and record the patient interaction. FIG. 9D shows an example Manage Triage Ticket form of the Triage Dashboard for a selected patient (e.g., “Irene Scott”), under an embodiment. If the patient has called for a symptom to be managed, the operator selects the appropriate Symptom Pathway and is prompted by the system to ask the patient particular questions appropriate to the symptom.

The patient is queried regarding their condition, the patient responses are recorded or entered into the care management system, and appropriate interventions are provided. FIGS. 9E1-5 shows an example page of the Triage Dashboard configured to receive patient responses to queries and provide appropriate interventions, under an embodiment. The system is configured to track Navigation Activities, if applicable. The provider creates a Follow-up task in the NCC in order to set up a reminder to follow-up with the patient to confirm their symptoms have subsided. FIG. 9F shows an example Follow-up Task form of the Triage Dashboard, under an embodiment. The Triage Ticket is resolved to create a record (e.g., PDF) of the patient interaction, and the patient is removed from the Triage Dashboard. FIG. 9G shows an example Triage Dashboard following resolution of the event and patient removal, under an embodiment. Upon removal of the patient from the Triage Dashboard, a record of the interaction is available on the Patient Detail page. FIG. 9H shows an example Follow-up page of the Triage Dashboard, under an embodiment.

The care management system, at a pre-specified time (e.g., next day, etc.) subsequent to resolution of the Triage Ticket, a badge is displayed on the Triage Dashboard Follow-ups view indicating a Follow-up is currently due. The operator navigates to the Follow-up view on the Triage Dashboard and opens the Follow-up Task, which includes the patient name, contact number, link to the corresponding Triage Ticket, and a description of the task. Contact is made with the patient in order to confirm status of the previously-reported symptoms, and upon receiving confirmation the Follow-up task is closed. The system is configured to track Navigation Activities, if applicable.

Numerous example scenarios follow involving the triage dashboard red alerts and yellow alerts as described herein. The examples presented herein are representative of care management system operations but operations are not limited to these example scenarios. These example alert scenarios assume the patient is a “standard patient” except where noted.

One dashboard alert example involves a Red alert triggered and managed on the same day. The Red alert is submitted (Standard or Elevated), and in response the Dashboard section is “Action Needed”, and the Alert Type is “Red alert” (see table) for the corresponding patient. The provider can move the patient to another Dashboard section (e.g., Watch Carefully or No Action Needed), causing the Dashboard section to present “Watch Carefully” or “No Action Needed”. Following this activity the Alert Type is Managed or none.

Example dashboard scenarios also include persisting alert scenarios. An example involves a Red alert that persists until patient status is updated. At Day 1 a Red alert is submitted (Standard or Elevated) and in response the Dashboard section is “Action Needed”, and the Alert Type is red alert. When the provider does not update the status of the patient, at Day 2 the patient's red alert persists, the Dashboard section is Action Needed, and the Alert Type is unmanaged red alert type, which persists until the status is updated.

Another example involving a Yellow alert that persists until next subsequent check-in by the patient. At Day 1, a Moderate side effect is detected and in response the Dashboard section is Watch Carefully, and the Alert Type is moderate side effect. At Day 2 no check-in by the patient occurs, and the Dashboard section is Watch Carefully, and the Alert Type is moderate side effect. At Day 3 patient reports no symptoms, and Dashboard section is No Action Needed, and Alert Type is none.

In another persisting alert example, a Red alert persists until patient status is updated, even when patient misses a check-in. At Day 1 a Red alert is submitted (Standard or Elevated), and the Dashboard section is Action Needed, and Alert Type is red alert. The provider does not update the patient's status. At Day 2 a Check-in occurs with no symptoms (Patient's red alert persists), so the Dashboard section is Action Needed, and Alert Type is unmanaged red alert. Again, the provider does not update the patient's status. At Day 3, No check-in occurs, so the Dashboard section remains as Action Needed, and the Alert Type remains as an unmanaged red alert.

Another set of examples includes scenarios involving triggering of different alerts. For example, different red and yellow alerts of an embodiment are triggered on the same day. A severe side effect is received (e.g., “Doctor paused my treatment”), and the Dashboard section is Action Needed, and Alert Type is [severe graphic] side effect, Paused.

Another example involves different red and yellow alerts triggered on different days. At Day 1 information is received of a Severe Rash. In response the Dashboard section is Action Needed, and the Alert Type is [severe graphic] Rash. The provider does not update the patient's status. At Day 2 information is received of Moderate Nausea or vomiting, so in the Dashboard section the patient remains in Action Needed, and the Alert Type is [severe graphic] Unmanaged Rash, [moderate graphic] Nausea or vomiting. The provider again does not update the patient's status. At Day 3 a report of No symptoms is received, so the Dashboard section is Action Needed, and the Alert Type is [severe graphic] Unmanaged Rash (the moderate symptom alert was removed because the patient checked in).

In yet another example, different red alerts are triggered on different days. At Day 1 report of a Severe Rash is received, so the Dashboard section is Action Needed, and the Alert Type is [severe graphic] Rash. The provider does not update the patient's status. At Day 2 Severe Nausea or vomiting is reported, so Dashboard section is patient remains in Action Needed, and Alert Type is [severe graphic] Unmanaged Rash, [severe graphic] Nausea or vomiting.

Scenarios involving triggering of different alerts include an example in which the same red alert is triggered on different days. At Day 1 a Severe side effect is reported, so the Dashboard section is Action Needed, and Alert Type is [severe graphic] side effect. The provider does not update the patient's status. At Day 2 the same severe side effect is reported, so the Dashboard section is Action needed, and Alert Type is [severe graphic] Unmanaged side effect.

An additional example involves red then yellow alerts triggered for the same side effect on different days. At Day 1 a Severe Rash is reported, so the Dashboard section is Action Needed, and Alert Type is [severe graphic] Rash. The provider does not update the patient's status. At Day 2 Moderate Rash is reported, so the Dashboard section is Action Needed, and Alert Type is [severe graphic] Unmanaged Rash, [moderate graphic] Rash. Again the provider does not update the patient's status. At Day 3 no side effects are reported, so the Dashboard section is Action Needed, and Alert Type is [severe graphic] Unmanaged Rash.

In another example, yellow then red alerts are triggered for the same side effect on different days. At Day 1 a Moderate Rash is reported. The Dashboard section is Watch Carefully, and Alert Type is [moderate graphic] Rash. The provider does not update the patient's status. At Day 2 Severe Rash is reported, so the Dashboard section is Action Needed, and Alert Type is [severe graphic] Rash.

FIG. 10 is a flow diagram for operations involving a missed check-in by a patient, under an embodiment. One example of missed check-in operations includes missed patient check-ins with provider managing. At Day 1 no patient check-in is reported. At Day 2 no check-in occurs, so the Dashboard section is Watch Carefully, and Alert Type is No entries for 2 days. Again at Day 3 no check-in occurs, so the Dashboard section is Action Needed, and Alert Type is No entries for 3 days. The provider does not update the patient's status. At Day 4 no check-in is reported so the Dashboard section is Action Needed, and Alert Type is No entries for 4 days. The provider updates the patient's status to Watch Carefully, and the patient moves to Watch Carefully with status of Managed. At Day 5 no check-in occurs so the Dashboard section is Watch Carefully, and Alert Type is Managed. At Day 6 no check-in occurs so the Dashboard section is Watch Carefully, and Alert Type is No entries for 2 days. At Day 7 no check-in occurs so the Dashboard section is Action Needed, and Alert Type is No entries for 3 days.

Another example of missed patient check-ins shows operations involving missed check-ins with a check-in, but provider not managing. At Day 1 no check-in occurs. At Day 2 no check-in occurs, so the Dashboard section is Watch Carefully, and Alert Type is No entries for 2 days. At Day 3 no check-in occurs, so the Dashboard section is Action Needed, and Alert Type is No entries for 3 days. The provider does not update the patient's status. At Day 4 the patient checks in with no symptoms, so the Dashboard section is No Action Needed, and Alert Type is none.

The example dashboard scenarios of embodiments include missed adherence scenarios. One example involves Missed adherence with standard alerts. At Day 1 there is No adherence, so the Dashboard section is No Action Needed, and Alert Type is none. At Day 2 there is again No adherence, so the Dashboard section is Watch Carefully, and Alert Type is Non-Adherence. The provider does not update the patient's status. At Day 3 there continues to be No adherence, so the Dashboard section is Action Needed, and Alert Type is Non-Adherence.

Another example involves missed adherence (standard alerts) with missed check-ins by the patient. At Day 1 there is No adherence, so the Dashboard section is No Action Needed, and Alert Type is none. At Day 2 a Missed check-in is detected, so the Dashboard section is No Action Needed, and Alert Type is none (because missed check in does not affect non-adherence). At Day 3 there is again No adherence, so the Dashboard section is Watch Carefully, and Alert Type is Non-Adherence. At Day 4 there is again No adherence, so the Dashboard section is Action Needed, and Alert Type is Non-Adherence.

Yet another example involves missed adherence (standard alerts) with more missed check-ins. At Day 1 there is No adherence, so the Dashboard section is No Action Needed, and Alert Type is none. At Day 2 a Missed check-in occurs, so the Dashboard section is No Action Needed, and Alert Type is none (because missed check in does not affect non-adherence). At Day 3 another Missed check-in occurs, so the Dashboard section is Watch Carefully, and Alert Type is No entries for 2 days. At Day 4 there is another Missed check-in, so the Dashboard section is Action Needed, and Alert Type is No entries for 3 days. The provider does not update the patient's status. At Day 5 there is yet another Missed check-in, so the Dashboard section is Action Needed, and Alert Type is No entries for 4 days. The provider does not update the patient's status. At Day 6 there is No adherence, so the Dashboard section is Watch Carefully (moved to watch carefully because they checked in and have non-adherence for 2 of the last 5 submitted check ins), and Alert Type is Non-Adherence. At Day 7 there is No adherence, so the Dashboard section is Action Needed, and Alert Type is Non-Adherence.

In another example, non-adherence is managed followed by more non-adherence. At Day 1 there is No adherence, so the Dashboard section is No Action Needed, and Alert Type is none. At Day 2 there is No adherence, so the Dashboard section is Watch Carefully, and Alert Type is Non-Adherence. At Day 3 there is No adherence, so the Dashboard section is Action Needed, and Alert Type is Non-Adherence. The provider updates patient's status to Watch Carefully, and patient moves to Watch Carefully with status of Managed. At Day 4 there is No adherence, so the Dashboard section is No Action Needed, and Alert Type is none.

Still another example involves missed adherence triggering red alerts (Elevated Patients). At Day 1 a Severe Rash is reported, so the Dashboard section is Action Needed, and Alert Type is [severe graphic] Rash. The provider does not update the patient's status. At Day 2 there is No adherence, and no symptoms. The Dashboard section is Action Needed, and Alert Type is [severe graphic] Unmanaged Rash, Non-Adherence.

The example dashboard scenarios also include a set of low participation scenarios. A low participation example of an embodiment includes Low participation for an Elevated Patient. At Day 1 a Mild Rash is reported, so the Dashboard section is Watch Carefully, and Alert Type is [mild graphic] Rash. At Day 2 there is No check-in, which brings participation less than specified threshold (e.g., 75%) (red alert). The Dashboard section is Action Needed, and Alert Type is Low participation, [mild graphic] Rash (moderate alert persists because there is no new check-in).

Examples also include Low participation for an Elevated Patient. At Day 1 there is No check-in, which brings participation less than specified threshold (e.g., 75%) (red alert). The Dashboard section is Action Needed, and Alert Type is Low participation. At Day 2 there is No check-in, and participation remains below threshold (red alert). The Dashboard section is Action Needed, and Alert Type is Low participation. The provider updates the patient's status to Watch Carefully, and the patient moves to Watch Carefully with status of Managed. At Day 3 there is Check-in with no symptoms, but participation remains below threshold. The Dashboard section is Action Needed, and Alert Type is Low participation.

Another example involves Low participation for a Standard Patient. At Day 1 there is No check-in, which brings participation less than specified threshold (e.g., 50%) (yellow alert). The Dashboard section is Watch Carefully, and Alert Type is Low participation. At Day 2 there continues to be No check-in, and participation remains below threshold (yellow alert). The Dashboard section is Watch Carefully, and Alert Type is Low participation. At Day 3, Check-in occurs with no symptoms reported, but participation remains below threshold. The Dashboard section is Watch Carefully, and Alert Type is Low participation.

Yet another example involves Low participation for Standard Patient. At Day 1 a Moderate Rash is reported. The Dashboard section is Watch Carefully, and Alert Type is [moderate graphic] Rash. At Day 2 there is No check-in, which brings participation less than specified threshold (e.g., 50%) (yellow alert). The Dashboard section is Watch Carefully, and Alert Type is Low participation, [moderate graphic] Rash.

The example dashboard scenarios also include a set of scenarios in which a patient moves out of a status. An example involves a patient Moving out of Watch Carefully. At Day 1 a Moderate side effect is reported. The Dashboard section is Watch Carefully, and Alert Type is moderate side effect. At Day 2 patient reports No symptoms, so Dashboard section is No Action Needed, and Alert Type is none.

Another example involves a patient Moving out of No Action Needed to Action Needed. At Day 1 no symptoms are reported, so the Dashboard section is No Action Needed, and Alert Type is none. The provider moves patient to Action Needed; patient has alert “Triaged by staff”. At Day 2 there is a Check-in with no symptoms. The Dashboard section is Action Needed, and Alert Type is none (or Triaged by staff). The patient remains in Action Needed until moved by the provider.

Yet another example involves a patient moving out of No Action Needed to Watch Carefully. At Day 1 no symptoms are reported, so the Dashboard section is No Action Needed, and Alert Type is none. The provider moves the patient to Watch Carefully; patient has alert “Triaged by staff”. At Day 2 a Check-in occurs with no symptoms, and the Dashboard section is No Action Needed, and Alert Type is none. The patient moves out of Watch Carefully with the next check-in to be consistent with Watch Carefully behavior.

In still another example involving a patient moving out of No Action Needed to Watch Carefully, at Day 1 there is No check-in so the Dashboard section is No Action Needed, and Alert Type is none. At Day 2 there is again No check-in, so the Dashboard section is Watch Carefully, and Alert Type is No entries for 2 days. At Day 3 a Check-in occurs with no symptoms, backfills missed adherence for Day 1 and 2. The Dashboard section is No Action Needed, and Alert Type is none (Adherence percentage and alert logic takes into account entries for Day 1 and Day 2).

In addition to the Health Tracker program, the care management system includes the Chronic Care Management (CCM) program. A patient having two or more chronic conditions (e.g. cancer, anemia, diabetes, chronic heart failure, etc.) is eligible to be enrolled in CCM. Upon identifying a patient as a candidate for CCM, the provider contacts the patient to collect a consent for CCM. The care management system is configured to navigate to the patient detail page and select “Enroll in Chronic Care Management”, which opens a consent form. The provider checks the consent checkbox indicating a consent form has been collected in the clinic and the patient has agreed to the terms of CCM. Upon completing enrollment of the patient, their name will appear on the CCM Time Tracking Dashboard (e.g., in the section titled “Below 20 min Billable Time”). The system is configured to edit a CCM patient at any time to change the Billable Provider. Further, the system is configured to opt a patient out, which removes the patient from the program and from the CCM Time Tracking Dashboard. Any accrued time will be saved for the patient, but future accrued time will not appear on the dashboard.

Patients enrolled in CCM accrue non face-to-face time as it is tracked in the Navigation Activity widget. When a CCM patient reaches a pre-specified threshold (e.g., 20 minutes, etc.) of accrued time (not face-to-face time) per calendar month, the patient is moved into the “Above 20 min Billable Time” section on the CCM Time Tracking Dashboard. Furthermore, the patient is listed on the Billing Report for the calendar month along with data including MRN, Billable Provider, date the threshold was reached, and the total time accrued.

The care management system is further configured to include OCM program patients. Upon identifying a patient as eligible for an OCM episode of care, the provider navigates to the patient detail page and selects “Start Episode”. The NCC is configured to enable selection of a start and end date for the episode of care based on the chemotherapy treatment schedule. Upon saving of the enrollment form the patient appears on the OCM Patients Dashboard. Upon being enrolled, the NCC is configured for use in creating a care plan, collecting a depression survey (if eligible), collecting a pain survey at every clinic visit, reporting Navigation Activities (when applicable), and collecting a distress survey.

When using the system to create a care plan, the provider navigates to the patient detail page, opens the “Care Plan” section, selects “Start Care Plan”, and enters information prompted for in the appropriate sections. FIG. 11A shows an example Patient Record, under an embodiment. FIG. 11B shows an example Navigation Activities section of the Patient Record, under an embodiment. FIG. 11C shows an example Patient Record with the menu dropdown to select between “Patient Record”, “Navigation Activities”, and “Care Plan” sections, under an embodiment. FIG. 11D shows an example Care Plan section of the Patient Record, under an embodiment. A Care Plan is accessed or initiated from the Care Plan section of the Patient Record.

During the information entry process, the patient detail page is configured to display the number of required sections completed. FIGS. 11E1-5 show an example Patient Detail Page of the Patient Record, under an embodiment. When the care plan is completed a file or record (e.g., PDF) is created, and the system can be configured to make the care plan record available to the patient in the patient portal. FIGS. 11F1-5 shows an example filled Care Plan record, under an embodiment. Further to the Care Plan, additional care plan documents can also be uploaded and shared with the patient. Figure HG shows an example Patient Record with Care Plan, under an embodiment. FIG. 11H shows an example Patient Record with Care Plan, including Care Plan creation information and controls for sharing the Care Plan, under an embodiment. FIG. 11I shows an example Patient Record with Care Plan, including Care Plan creation information and shared status information, under an embodiment. FIGS. 11J1-5 show an example completed Care Plan record, under an embodiment.

The care management system is configured to collect a pain, depression or distress survey for OCM enrolled patients. When a patient enters the clinic they are provided access to a touch screen tablet or computer kiosk for use in submitting distress and pain screening information. If the information entered by the patient indicates depression as a problem, then the system generates a depression screening for the patient. If a patient does not complete a screening in kiosk mode, the provider can navigate to the patient detail page and select “Collect” to open a survey and walk through the survey with the patient (e.g., FIG. 11A, “Collect Distress”, “Collect PHQ-9”, “Collect NRS”). Once a survey is completed, a file (e.g., PDF) version of the survey submission is available on the patient detail page in the Patient Record. The system automatically generates a Triage Ticket if a patient condition triggers a red alert. Within the Triage Ticket, a pain care plan or psychosocial follow-up is documented, and populates the patients existing comprehensive care plan.

When reporting Navigation Activities of OCM enrolled patients, the healthcare provider navigates to the patient detail page, and from the Navigation Activity detail, selects the relevant Navigation tasks (e.g., FIG. 11B). Optionally, a time is recorded for the activity and/or a note description for the activity is added. This information is saved to log to record the Navigation Activity for the patient.

In addition to the Patient Reported Outcomes Dashboard and the Triage Dashboard, the care management dashboards include but are not limited to a CCM Time Tracked Dashboard, and OCM Patients Dashboard. FIG. 12 shows an example CCM Time Tracked Dashboard, under an embodiment. The CCM Time Tracking Dashboard is configured to include a list of patients enrolled in CCM, stratified by whether they have become eligible for CCM billing for the calendar month. The CCM Time Tracking Dashboard prioritizes the patients who have not exceeded a pre-specified threshold (e.g., 20 minutes, etc.) of accrued time (not face-to-face time) per calendar month, and is configured to notify the billing team of those patients that have accrued time exceeding the threshold amount. FIG. 13 shows an example CCM Billing Report, under an embodiment.

FIG. 14 shows an example OCM Patients Dashboard, under an embodiment. The OCM Patients Dashboard is configured to include a list of patients enrolled in OCM, and identify the actions that are outstanding for the episode of care (e.g., create a care plan, collect a depression survey, etc.). The OCM Patients Dashboard therefore prioritizes the patients having an outstanding care need in order to meet OCM requirements.

Embodiments include a system comprising a platform including a processor and a database. The system includes a patient application running on a remote device. The patient application is configured to present patient data inquiries and, in response, receive patient data of a corresponding patient at the remote device. The patient data includes data of medication and physical condition. The system includes a provider application running on the platform and configured to receive and process the patient data from the remote device. At least one of the provider application and the patient application is configured to generate the patient data inquiries using information of the patient data reported during at least one prior session. The provider application is configured to generate a plurality of provider dashboards configured to include the patient data and controls for interacting with the corresponding patient and recording care data. The provider application is configured to automatically control classification of patients and generate care notifications based on the patient data and include the classification and care notifications on the plurality of provider dashboards.

Embodiments include a system comprising: a platform including a processor and a database; a patient application running on a remote device, wherein the patient application is configured to present patient data inquiries and, in response, receive patient data of a corresponding patient at the remote device, wherein the patient data includes data of medication and physical condition; and a provider application running on the platform and configured to receive and process the patient data from the remote device, wherein at least one of the provider application and the patient application is configured to generate the patient data inquiries using information of the patient data reported during at least one prior session, wherein the provider application is configured to generate a plurality of provider dashboards configured to include the patient data and controls for interacting with the corresponding patient and recording care data, wherein the provider application is configured to automatically control classification of patients and generate care notifications based on the patient data and include the classification and care notifications on the plurality of provider dashboards.

The provider application is configured to generate a historical record of the patient data of the corresponding patient.

The patient data includes patient reported outcomes.

The patient data includes severity data.

The patient data includes medication adherence data.

The patient data includes program participation data.

The patient data includes pain data.

The patient data includes depression data.

The patient data includes distress data.

The patient data includes allergy data.

The patient data includes diagnosis and prognosis data.

The patient data includes medication data.

The patient data includes treatment data including at least one of a treatment goal, a treatment plan, and treatment cost data.

The patient data includes procedure data including at least one of surgery, transplant, radiation, and chemotherapy data.

The patient data includes quality of life data.

The provider application is configured to analyze the patient data to detect depression and, in response to detecting depression, generates a depression screening for the patient.

The care data includes provider notations of patient interaction.

The at least one of the provider application and the patient application is configured to generate additional patient data inquiries during a current session in response to the patient data received during the current session.

The at least one of the provider application and the patient application is configured to generate the patient data inquiries using information of the patient data reported during a plurality of prior sessions.

The classification includes at least one of a mild, moderate, and severe classification based on the patient data.

The patient data includes side effect data.

The at least one of the provider application and the patient application is configured to generate additional patient data inquiries via the patient application in response to receiving the side effect data.

The classification includes a mild classification based on the side effect data.

The classification includes a moderate classification based on the side effect data.

The classification includes a severe classification based on the side effect data.

The care notifications include alerts.

The alerts include standard alerts and elevated alerts.

The standard alerts comprise standard yellow alerts triggered by the moderate classification, wherein the care notifications include notification to watch carefully.

The standard yellow alerts are triggered by at least one of no patient check in for a first time period, no medication adherence over a specified number of check-ins, patient participation below a first threshold for a second time period, treatment paused, and classification updated.

The standard alerts comprise standard red alerts triggered by the severe classification, wherein the care notifications include notification action is needed regarding care of the corresponding patient.

The standard red alerts are triggered by at least one of no medication adherence over a specified number of check-ins, no patient check in for a third time period, patient reporting out of medication, patient requesting call from provider, and patient requesting pain management.

The elevated alerts comprise elevated yellow alerts triggered by the mild classification, wherein the care notifications include notification to watch carefully.

The elevated yellow alerts are triggered by at least one of no patient check in for a fourth time period, classification updated, and treatment paused.

The elevated alerts comprise elevated red alerts triggered by the moderate classification, wherein the care notifications include notification to contact the corresponding patient.

The elevated red alerts are triggered by at least one of no medication adherence, no patient check in for a fifth time period, patient reporting out of medication, patient requesting call from provider, patient participation below a second threshold for a sixth time period, and patient requesting pain management.

The care notifications include a notification to monitor the patient.

The care notifications include a notification the patient has not checked in via the patient application.

The care notifications include a notification of low medication adherence by the patient.

The care notifications include a notification of low participation relative to program goals.

The care notifications include a follow-up notification to follow up with a corresponding patient.

The at least one of the provider application and the patient application is configured to determine the alerts by evaluating the patient data received against criteria.

The at least one of the provider application and the patient application is configured to determine the alerts by separately evaluating patient data of a single session.

The at least one of the provider application and the patient application is configured to determine the alerts by evaluating patient data of a plurality of sessions.

The provider application generates the classification of patients and care notifications as components of at least one of the plurality of provider dashboards.

The plurality of provider dashboards includes a patient reported outcomes dashboard.

The patient reported outcomes dashboard includes a plurality of patients.

The patient reported outcomes dashboard is configured to include a list of patients arranged according to classification.

The patient reported outcomes dashboard is configured to include the patient data and care notifications for the plurality of patients and to present the patient data and care notifications for a selected patient.

The patient reported outcomes dashboard is configured to receive the patient data and the provider notations.

The patient reported outcomes dashboard is configured to record time spent on patient care activity.

The patient reported outcomes dashboard is configured to edit the patient data.

The plurality of provider dashboards includes a triage dashboard.

The triage dashboard is configured to include a list of patients having acute care needs.

The list of patients is prioritized into sections according to urgency of need for care.

The sections include at least one of emergency, action needed immediately, and action needed today.

The triage dashboard is configured to include a triage incident ticket, wherein the triage incident ticket is activated in response to a patient reporting a specific need to interact the provider.

The triage incident ticket is configured to receive the patient data of the patient interaction.

The triage dashboard is configured to maintain the triage incident ticket in an active state until the specific need is resolved.

The triage dashboard is configured to generate a follow-up task when the triage incident ticket is to remain in an active state.

The care notifications include a triage follow-up notification when the follow-up is due.

The triage dashboard is configured to close the triage incident ticket and create a permanent record of the interaction upon resolution of the triage incident ticket.

At least one of the plurality of provider dashboards is configured to track time spent on patient care activity.

At least one of the plurality of provider dashboards is configured for an oncology care model episode program.

At least one of the plurality of provider dashboards is configured as a care plan, wherein the care plan includes at least one of diagnosis and prognosis data, pain management data, allergy data, medication data, treatment data, procedure data, and quality of life data.

Embodiments include a method comprising configuring a patient application to execute on a remote device to present patient data inquiries and, in response, receive patient data of a corresponding patient at the remote device. The patient data includes data of medication and physical condition. Patient data inquires are generated using information of the patient data reported during at least one prior session. The method includes configuring a provider application to execute on a platform to receive and process the patient data from the remote device. The method includes configuring the provider application to generate a plurality of provider dashboards that include the patient data and controls for interacting with the corresponding patient and recording care data. The method includes configuring the provider application to automatically control classification of patients and generate care notifications based on the patient data and include the classification and care notifications on the plurality of provider dashboards. The patient application and the provider application interact to automate at least a portion of patient interaction and management.

Embodiments include a method comprising: configuring a patient application to execute on a remote device to present patient data inquiries and, in response, receive patient data of a corresponding patient at the remote device, wherein the patient data includes data of medication and physical condition, wherein the patient data inquires are generated using information of the patient data reported during at least one prior session; configuring a provider application to execute on a platform to receive and process the patient data from the remote device; configuring the provider application to generate a plurality of provider dashboards that include the patient data and controls for interacting with the corresponding patient and recording care data; configuring the provider application to automatically control classification of patients and generate care notifications based on the patient data and include the classification and care notifications on the plurality of provider dashboards, wherein the patient application and the provider application interact to automate at least a portion of patient interaction and management.

The components described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, HTTPs, FTP, SMTP, WAP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

What is claimed is:

1. A system comprising:
a platform including a processor and a database;
a patient application running on a remote device, wherein the patient application is configured to present patient data inquiries and, in response, receive patient data of a corresponding patient at the remote device, wherein the patient data includes data of medication and physical condition; and
a provider application running on the platform and configured to receive and process the patient data from the remote device, wherein at least one of the provider application and the patient application is configured to generate the patient data inquiries using information of the patient data reported during at least one prior session, wherein the provider application is configured to generate a plurality of provider dashboards configured to include the patient data and controls for interacting with the corresponding patient and recording care data, wherein the provider application is configured to automatically control classification of patients and generate care notifications based on the patient data and include the classification and care notifications on the plurality of provider dashboards.

2. The system of claim 1, wherein the provider application is configured to generate a historical record of the patient data of the corresponding patient.

3. The system of claim 1, wherein the patient data includes patient reported outcomes.

4. The system of claim 1, wherein the patient data includes severity data.

5. The system of claim 1, wherein the patient data includes medication adherence data.

6. The system of claim 1, wherein the patient data includes program participation data.

7. The system of claim 1, wherein the patient data includes pain data.

8. The system of claim 1, wherein the patient data includes depression data.

9. The system of claim 1, wherein the patient data includes distress data.

10. The system of claim 1, wherein the patient data includes allergy data.

11. The system of claim 1, wherein the patient data includes diagnosis and prognosis data.

12. The system of claim 1, wherein the patient data includes medication data.

13. The system of claim 1, wherein the patient data includes treatment data including at least one of a treatment goal, a treatment plan, and treatment cost data.

14. The system of claim 1, wherein the patient data includes procedure data including at least one of surgery, transplant, radiation, and chemotherapy data.

15. The system of claim 1, wherein the patient data includes quality of life data.

16. The system of claim 1, wherein the provider application is configured to analyze the patient data to detect depression and, in response to detecting depression, generates a depression screening for the patient.

17. The system of claim 1, wherein the care data includes provider notations of patient interaction.

18. The system of claim 1, wherein the at least one of the provider application and the patient application is configured to generate additional patient data inquiries during a current session in response to the patient data received during the current session.

19. The system of claim 1, wherein the at least one of the provider application and the patient application is configured to generate the patient data inquiries using information of the patient data reported during a plurality of prior sessions.

20. The system of claim 1, wherein the classification includes at least one of a mild, moderate, and severe classification based on the patient data.

21. The system of claim 20, wherein the patient data includes side effect data.

22. The system of claim 21, wherein the at least one of the provider application and the patient application is configured to generate additional patient data inquiries via the patient application in response to receiving the side effect data.

23. The system of claim 21, wherein the classification includes a mild classification based on the side effect data.

24. The system of claim 21, wherein the classification includes a moderate classification based on the side effect data.

25. The system of claim 21, wherein the classification includes a severe classification based on the side effect data.

26. The system of claim 21, wherein the care notifications include alerts.

27. The system of claim 26, wherein the alerts include standard alerts and elevated alerts.

28. The system of claim 27, wherein the standard alerts comprise standard yellow alerts triggered by the moderate classification, wherein the care notifications include notification to watch carefully.

29. The system of claim 28, wherein the standard yellow alerts are triggered by at least one of no patient check in for a first time period, no medication adherence over a specified number of check-ins, patient participation below a first threshold for a second time period, treatment paused, and classification updated.

30. The system of claim 28, wherein the standard alerts comprise standard red alerts triggered by the severe classification, wherein the care notifications include notification action is needed regarding care of the corresponding patient.

31. The system of claim 30, wherein the standard red alerts are triggered by at least one of no medication adherence over a specified number of check-ins, no patient check in for a third time period, patient reporting out of medication, patient requesting call from provider, and patient requesting pain management.

32. The system of claim 27, wherein the elevated alerts comprise elevated yellow alerts triggered by the mild classification, wherein the care notifications include notification to watch carefully.

33. The system of claim 32, wherein the elevated yellow alerts are triggered by at least one of no patient check in for a fourth time period, classification updated, and treatment paused.

34. The system of claim 32, wherein the elevated alerts comprise elevated red alerts triggered by the moderate classification, wherein the care notifications include notification to contact the corresponding patient.

35. The system of claim 34, wherein the elevated red alerts are triggered by at least one of no medication adherence, no patient check in for a fifth time period, patient reporting out of medication, patient requesting call from provider, patient participation below a second threshold for a sixth time period, and patient requesting pain management.

36. The system of claim 1, wherein the care notifications include a notification to monitor the patient.

37. The system of claim 1, wherein the care notifications include a notification the patient has not checked in via the patient application.

38. The system of claim 1, wherein the care notifications include a notification of low medication adherence by the patient.

39. The system of claim 1, wherein the care notifications include a notification of low participation relative to program goals.

40. The system of claim 1, wherein the care notifications include a follow-up notification to follow up with a corresponding patient.

41. The system of claim 1, wherein the at least one of the provider application and the patient application is configured to determine the alerts by evaluating the patient data received against criteria.

42. The system of claim 41, wherein the at least one of the provider application and the patient application is configured to determine the alerts by separately evaluating patient data of a single session.

43. The system of claim 41, wherein the at least one of the provider application and the patient application is configured to determine the alerts by evaluating patient data of a plurality of sessions.

44. The system of claim 1, wherein the provider application generates the classification of patients and care notifications as components of at least one of the plurality of provider dashboards.

45. The system of claim 44, wherein the plurality of provider dashboards includes a patient reported outcomes dashboard.

46. The system of claim 45, wherein the patient reported outcomes dashboard includes a plurality of patients.

47. The system of claim 45, wherein the patient reported outcomes dashboard is configured to include a list of patients arranged according to classification.

48. The system of claim 45, wherein the patient reported outcomes dashboard is configured to include the patient data and care notifications for the plurality of patients and to present the patient data and care notifications for a selected patient.

49. The system of claim 45, wherein the patient reported outcomes dashboard is configured to receive the patient data and the provider notations.

50. The system of claim 45, wherein the patient reported outcomes dashboard is configured to record time spent on patient care activity.

51. The system of claim 45, wherein the patient reported outcomes dashboard is configured to edit the patient data.

52. The system of claim 44, wherein the plurality of provider dashboards includes a triage dashboard.

53. The system of claim 52, wherein the triage dashboard is configured to include a list of patients having acute care needs.

54. The system of claim 53, wherein the list of patients is prioritized into sections according to urgency of need for care.

55. The system of claim 54, wherein the sections include at least one of emergency, action needed immediately, and action needed today.

56. The system of claim 52, wherein the triage dashboard is configured to include a triage incident ticket, wherein the triage incident ticket is activated in response to a patient reporting a specific need to interact the provider.

57. The system of claim 56, wherein the triage incident ticket is configured to receive the patient data of the patient interaction.

58. The system of claim 57, wherein the triage dashboard is configured to maintain the triage incident ticket in an active state until the specific need is resolved.

59. The system of claim 58, wherein the triage dashboard is configured to generate a follow-up task when the triage incident ticket is to remain in an active state.

60. The system of claim 59, wherein the care notifications include a triage follow-up notification when the follow-up is due.

61. The system of claim 56, wherein the triage dashboard is configured to close the triage incident ticket and create a permanent record of the interaction upon resolution of the triage incident ticket.

62. The system of claim 1, wherein at least one of the plurality of provider dashboards is configured to track time spent on patient care activity.

63. The system of claim 1, wherein at least one of the plurality of provider dashboards is configured for an oncology care model episode program.

64. The system of claim 1, wherein at least one of the plurality of provider dashboards is configured as a care plan, wherein the care plan includes at least one of diagnosis and prognosis data, pain management data, allergy data, medication data, treatment data, procedure data, and quality of life data.

65. A method comprising:
configuring a patient application to execute on a remote device to present patient data inquiries and, in response, receive patient data of a corresponding patient at the remote device, wherein the patient data includes data of medication and physical condition, wherein the patient data inquires are generated using information of the patient data reported during at least one prior session;
configuring a provider application to execute on a platform to receive and process the patient data from the remote device;
configuring the provider application to generate a plurality of provider dashboards that include the patient data and controls for interacting with the corresponding patient and recording care data;
configuring the provider application to automatically control classification of patients and generate care notifications based on the patient data and include the classification and care notifications on the plurality of provider dashboards, wherein the patient application and the provider application interact to automate at least a portion of patient interaction and management.
